(19) United States
(12) Patent Application Publication
(10) Pub. No.: US 2023/0167331 A1
(43) Pub. Date: Jun. 1, 2023

(54) Ink Set And Recording Method

(71) Applicant: SEIKO EPSON CORPORATION, Tokyo (JP)

(72) Inventors: Keigo ANDO, Matsumoto (JP); Takako SUGIYAMA, Azumino (JP); Mitsuaki KOSAKA, Minowa (JP)

(21) Appl. No.: 18/070,002

(22) Filed: Nov. 28, 2022

(30) Foreign Application Priority Data
Nov. 29, 2021 (JP) 2021-192855

(51) Int. Cl. C09D 133/08; C09D 11/40; B41M 7/00

(52) U.S. Cl. CPC C09D 133/08; C09D 11/40; B41M 7/009

(57) ABSTRACT

An ink set includes a black ink composition containing a black colorant and a chromatic ink composition containing a colorant and is used for recording on a low-absorbing or a non-absorbing recording medium. In the ink set, the black ink composition and the chromatic ink composition are both water-based ink jet inks, the chromatic ink composition contains a silicone-based surfactant 1 in which in a molecular weight distribution by a gel permeation chromatography, the maximum peak in a molecular weight range of 300 or more is located in a range of 3,000 to 20,000, and the black ink composition contains at least one of a glycol monoether solvent and a silicone-based surfactant 2 in which in a molecular weight distribution by a gel permeation chromatography, the maximum peak in a molecular weight range of 300 or more is located in a range of 300 to 1,500.

The present application is based on, and claims priority from JP Application Serial Number 2021-192855, filed Nov. 29, 2021, the disclosure of which is hereby incorporated by reference herein in its entirety.

### BACKGROUND

### 1. Technical Field

The present disclosure relates to an ink set and a recording method.

### 2. Related Art

Since being able to record a highly fine image by a relatively simple apparatus, an ink jet recording method has been rapidly developed in various fields. In particular, there have been performed various studies on recording which is performed on a recording medium having a low liquid absorbing property using an ink set including at least two types of inks each containing water as a primary solvent.

For example, JP-A-2019-167451 has disclosed an ink set which is used for recording on a recording medium having a low liquid absorbing property and which includes a black ink (black ink composition) and a color ink (chromatic ink composition) each containing a silicone-based surfactant and water as a primary solvent.

However, in a related ink set, since a black ink has not a preferable wet spreadability on a recording medium, an image quality of a black image is inferior, and since color mixing occurs between the black ink and a color ink, an image quality (boundary bleeding) is degraded; hence, it is difficult to simultaneously satisfy the two types of image qualities described above.

### SUMMARY

According to an aspect of the present disclosure, there is provided an ink set which includes a black ink composition containing a black colorant and a chromatic ink composition containing a colorant and which is used for recording on a low-absorbing recording medium or a non-absorbing recording medium. In the ink set described above, the black ink composition and the chromatic ink composition are each a water-based ink jet ink, the chromatic ink composition contains a silicone-based surfactant 1 in which in a molecular weight distribution by a gel permeation chromatography, the maximum peak in a molecular weight range of 300 or more is located in a range of 3,000 to 20,000, and the black ink composition contains at least one selected from a glycol monoether solvent and a silicone-based surfactant 2 in which in a molecular weight distribution by a gel permeation chromatography, the maximum peak in a molecular weight range of 300 or more is located in a range of 300 to 1,500.

According to another aspect of the present disclosure, there is provided a recording method which performs recording on a recording medium which is a low-absorbing recording medium or a non-absorbing recording medium using the ink set according to the aspect described above, and the method comprises: a black ink adhesion step of adhering the black ink composition to the recording medium by an ink jet method; and a chromatic ink adhesion step of adhering the chromatic ink composition to the recording medium by an ink jet method.

### BRIEF DESCRIPTION OF THE DRAWINGS

FIG. 1 is a schematic view showing one example of an ink jet recording apparatus.

FIG. 2 is a schematic view of a carriage and its periphery of the example of the ink jet recording apparatus.

### DESCRIPTION OF EXEMPLARY EMBODIMENTS

Hereinafter, embodiments of the present disclosure will be described. The following embodiments are described to explain examples of the present disclosure. The present disclosure is not at all limited to the following embodiments and includes various types of changed and/or modified embodiments to be performed without departing from the scope of the present disclosure. In addition, all the structures described below are not always required to be essential structures. 1. INK SET

An ink set according to one embodiment of the present disclosure includes a black ink composition containing a black colorant and a chromatic ink composition containing a colorant and is used for recording on a low-absorbing recording medium or a non-absorbing recording medium. In the ink set described above, the black ink composition and the chromatic ink composition are each a water-based ink jet ink, the chromatic ink composition contains a silicone-based surfactant 1 in which in a molecular weight distribution by a gel permeation chromatography, the maximum peak in a molecular weight range of 300 or more is located in a range of 3,000 to 20,000, and the black ink composition contains at least one selected from a glycol monoether solvent and a silicone-based surfactant 2 in which in a molecular weight distribution by a gel permeation chromatography, the maximum peak in a molecular weight range of 300 or more is located in a range of 300 to 1,500.

Hereinafter, the “silicone-based surfactant 1 in which in a molecular weight distribution by a gel permeation chromatography, the maximum peak in a molecular weight range of 300 or more is located in a range of 3,000 to 20,000” is called the “specific silicone-based surfactant 1” or is also simply called the “silicone-based surfactant 1”. In addition, the “silicone-based surfactant 2 in which in a molecular weight distribution by a gel permeation chromatography, the maximum peak in a molecular weight range of 300 or more is located in a range of 300 to 1,500” is called the “specific silicone-based surfactant 2” or is also simply called the “silicone-based surfactant 2”. In addition, when the black ink composition (black ink) and the chromatic ink composition (color ink) are not particularly discriminated from each other, they are each also simply called the “ink composition” or the “ink”.

When the recording is performed on a non-absorbing recording medium or a low-absorbing recording medium which is a recording medium absorbing no liquid, such as the ink, or a recoding medium absorbing almost no liquid, respectively, in order to obtain an excellent image quality and the like, the ink is required to wet-spread on the recording medium described above. In particular, the black ink is frequently used to record an image including fine lines, such as characters. Accordingly, when the black ink is inferior in terms of wet spreadability, a high quality fine line is difficult to draw, and for example, the line is thinned and/or broken, so that the characters and the like are difficult to read. Hence, in particular, the black ink is required to have the wet spreadability, and a black ink having an excellent wet spreadability has been pursued.

In addition, when the recording is performed on a non-absorbing recording medium or a low-absorbing recording medium, the ink is not absorbed in the recording medium and is liable to remain thereon. Hence, an ink droplet is brought into contact with another ink droplet having a different color on the recording medium, and as a result, inter-color mixing is liable to occur between the inks. In particular, when a black ink droplet intrudes into a color ink droplet, a color portion of an image contaminated by a black color is conspicuous, and hence, the image is liable to be degraded. On the other hand, even if a color ink droplet intrudes into a black ink droplet, a color ink at a black portion of the image is inconspicuous, and hence, the image is not likely to be degraded. Accordingly, an ink composition is preferentially formed such that a black ink droplet is not likely to intrude into a color ink droplet.

For example, as the ink composition, when a content of a component, such as a silicone-based surfactant, which enhances the permeability of the ink by decreasing a surface tension thereof is set lower in the black ink than that in the color ink, the black ink droplet is made difficult to intrude into the color ink droplet. However, in the ink composition as described above, the wet spreadability of the black ink on a recording medium is not sufficient, the problem described above occurs, and the color development property (OD value) of the black image is degraded. Furthermore, when the wet spreadability is not sufficient, since the ink may not uniformly spread in a solid pattern of the image, irregularity in terms of image quality is also generated.

It was recently found that when a glycol monoether solvent or a specific silicone-based surfactant 2 having a low molecular weight is contained in a black ink, the wet spreadability and the color development property of the black ink can be made excellent. However, at a portion on a recording medium at which a black ink droplet and a color ink droplet are brought into contact with each other, color mixing between the colors occurs, and hence, the image quality is degraded. The reason for this is believed that since the glycol monoether solvent or the specific silicone-based surfactant 2 is contained, the black ink has a higher permeability and is liable to intrude into the color ink.

Accordingly, through more intensive research carried out by the present inventor, the color mixing described above can be prevented when a specific silicone-based surfactant 1 having a high molecular weight is contained in the color ink. The reason for this is believed that since the specific silicone-based surfactant 1 has a relatively high molecular weight, an ink droplet containing the above component has a function to block the intrusion of another ink droplet. In particular, when a solvent component of the ink is evaporated on a recording medium, and a solid content component has a high concentration, the black ink droplet is difficult to intrude into the color ink droplet.

As described above, according to the ink set of this embodiment, since the wet spreadability of the black ink on a recording medium is excellent, the color development property (OD value) of a black image can be made excellent, and in addition, since the color mixing between the black ink and the color ink can be significantly reduced, an excellent image quality (boundary bleeding) can be obtained.

The “ink set” in the present disclosure indicates a black ink composition and a chromatic ink composition which are used in combination as a set for recording. The black ink composition and the chromatic ink composition included in the ink set may be separately received in different ink containers or in different chambers of an integral ink container.

The ink set includes at least one (one type) black ink composition and at least one (one type) chromatic ink composition. The number of the at least one black ink composition may be at least two, and/or the number of the at least one chromatic ink composition may be at least two.

Hereinafter, the components contained in the black ink composition and the chromatic ink composition included in the ink set according to this embodiment will be described.

### 1.1. Black Ink Composition

The black ink composition included in the ink set according to this embodiment is a water-based ink jet ink and at least contains a black colorant and a glycol monoether solvent and/or a specific silicone-based surfactant 2.

In the present disclosure, the “water-based” ink jet ink indicates an ink which at least uses water as a primary solvent. In addition, the “ink jet ink” indicates an ink to be ejected from an ink jet head by an ink jet method and to be used for recording.

### 1.1.1. Black Colorant

The black ink composition included in the ink set according to this embodiment contains a black colorant.

### 1.1.1.1. Black Colorant

As the black colorant, both a black pigment and a black dye may be used. In addition, the black ink composition preferably contains a black pigment, and the pigment described above may be dispersed by a dispersion resin.

As the black pigment, a carbon black, such as a furnace black, a lamp black, an acetylene black, or a channel black, may be mentioned, and for example, C.I (Colour Index Generic Name) Pigment Black 1, 7, or 11 may be mentioned. Among those mentioned above, a carbon black which is C.I. Pigment Black 7 is preferably used.

As a concrete example of the carbon black, for example, there may be mentioned No. 2300, No. 900, MCF88, No. 33, No. 40, No. 45, No. 52, MA7, MA8, MA100, or No. 2200B (manufactured by Mitsubishi chemical Co., Ltd); Raven (registered trademark) 5750, 5250, 5000, 3500, 1255, or 700 (manufactured by Colombia Carbon Co., Ltd.); Regal (registered trademark) 400R, 330R, or 660R, Mogul (registered trademark) L, or Monarch (registered trademark) 700, 800, 880, 900, 1000, 1100, 1300, or 1400 (manufactured by Cabot Corporation); or Color Black FW1, FW2, FW2V, FW18, FW200, S150, S160, or S170, Printex (registered trademark) 35, U, V, or 140U, or Special Black 6, 5, 4A, or 4 (manufactured by Degussa).

In addition, in order to enhance the dispersibility of the pigment including the black pigment in the ink, the pigment is preferably surface-treated or is mixed with a dispersant. A surface treatment of the pigment is a method in which a functional group having an affinity with an ink medium is incorporated on particle surfaces of the pigment by a physical treatment or a chemical treatment. As is the case of this embodiment, when the pigment is used for a water-based ink, a hydrophilic group, such as a carboxy group or a sulfo group, is preferably incorporated.

When the dispersant is mixed with the ink composition, a dispersant having a hydrophobic section (hydrophobic group) and a hydrophilic section (hydrophilic group) in its molecular structure is preferably used. The dispersant as described above has an action such that the hydrophobic section is adsorbed to particle surfaces of the pigment, and the hydrophilic section is oriented at an aqueous medium side of the ink. By the action described above, the pigment can be more stably contained in the ink in the form of a dispersion. Although the dispersant as described above is not particularly limited, for example, there may be mentioned an acrylic-based resin, a styrene-acrylic-based resin, such as a styrene-(meth)acrylic acid copolymer or a styrene-(meth)acrylic acid-(meth)acrylate copolymer, a styrene-maleic acid-based resin, a salt of one of those mentioned above, or a formalin condensate of an aromatic sulfonic acid salt, and at least one selected from the group consisting of those mentioned above may be used. In addition, as the dispersant, a commercially available product may also be used.

In addition, a method in which the dispersibility is imparted by covering the particles of the pigment with a resin or the like may also be used. As a method of covering the particles of the pigment, for example, an acid precipitation method, a phase inversion emulsification method, or a miniemulsion polymerization method may be used.

As the black dye, for example, there may be mentioned C.I. Acid Black 1, 2, 24, or 94, C.I. Food Black 1 or 2, C.I. Direct Black 19, 38, 51, 71, 154, 168, 171, or 195, or C.I. Reactive Black 3, 4, or 35.

The black colorant may be used alone, or at least two types thereof may be used in combination.

Although a content of the black colorant can be appropriately adjusted in accordance with application, the content described above with respect to a total mass of the black ink composition is preferably 0.1 to 17.0 percent by mass, more preferably 0.2 to 15.0 percent by mass, further preferably 1.0 to 10.0 percent by mass, and particularly preferably 2.0 to 5.0 percent by mass. In addition, even when a colorant other than the black colorant is contained, the content described above may also be set in the range described above.

1.1.1.2. Colorant Other than Black Colorant

The black ink composition may contain a colorant other than the black colorant described above. The colorant as described above will be described later.

### 1.1.2. Water

The black ink composition included in the ink set according to this embodiment is a water-based ink jet ink and contains water. The water-based ink is an ink composition at least containing water as a primary solvent component. The ink jet ink is an ink used for recording on recording medium by an ink jet method.

Although the water is not particularly limited, for example, there may be mentioned pure water, such as ion exchange water, ultrafiltration water, reverse osmosis water, or distilled water, or water, such as ultrapure water, in which ionic impurities are removed as much as possible. In addition, in the case in which water sterilized by ultraviolet radiation, addition of hydrogen peroxide, or the like is used, generation of fungi and bacteria can be prevented when the ink composition is stored for a long time. Accordingly, the storage stability tends to be further improved.

A content of the water with respect to the total mass of the black ink composition is preferably 40 percent by mass or more, more preferably 45 percent by mass or more, even more preferably 50 percent by mass or more, further preferably 55 percent by mass or more, even further preferably 60 percent by mass or more, and particularly preferably 65 percent by mass or more. In addition, although an upper limit of the content of the water is not particularly limited, the upper limit described above with respect to the total mass of the black ink composition is preferably 90 percent by mass or less and more preferably 80 percent by mass or less.

### 1.1.3. Surfactant

The black ink composition included in the ink set according to this embodiment contains at least one selected from the glycol monoether solvent which will be described later and the silicone-based surfactant 2 (specific silicone-based surfactant 2) in which in a molecular weight distribution by a gel permeation chromatography, the maximum peak in a molecular weight range of 300 or more is located in a range of 300 to 1,500.

Since the specific silicone-based surfactant 2 as described above is not likely to be evaporated on a recording medium as compared to the glycol monoether solvent, a high permeability is maintained, and the wet spreadability is particularly made excellent.

In addition, the black ink composition included in the ink set according to this embodiment may contain the glycol monoether solvent which will be described later and the specific silicone-based surfactant 2. In the case described above, the wet spreadability, the abrasion resistance, and the prevention of inter-color mixing tend to be preferably adjusted with a good balance.

### 1.1.3.1. Specific Silicone-Based Surfactant 2

In the molecular weight distribution by a gel permeation chromatography (GPC), the specific silicone-based surfactant 2 has the maximum peak in a molecular weight range of 300 or more located in a range of 300 to 1,500. Since the silicone-based surfactant 2 as described above is contained, the wet spreadability can be further improved.

The maximum peak of the specific silicone-based surfactant 2 in a molecular weight range of 300 or more is located in a range of 300 to 1,500, preferably in a range of 500 to 1,500, more preferably in a range of 700 to 1,500, even more preferably in a range of 700 to 1,300, further preferably in a range of 800 to 1,100, and particularly preferably in a range of 900 to 1,000.

Since the maximum peak in a molecular weight range of 300 or more is located in a range of 300 to 1,500 and preferably in the range described above, the wet spreadability is further improved, and the image quality (OD value), the image quality (irregularity), the abrasion resistance, and the like tend to be further improved.

The maximum peak of the specific silicone-based surfactant 2 in a molecular weight range of 300 or more can be identified from a chart of a molecular weight distribution obtained by a GPC in which the horizontal axis represents “logarithm value of molecular weight M (Log M)” and the vertical axis represents “differential value of concentration fraction (dw/d(Log M))”. In addition, the “maximum peak” in this case indicates the maximum peak among peaks (mountains) present in a molecular weight range of 300 or more. In addition, the “maximum peak in a molecular weight range of 300 or more” indicates that peaks in a molecular weight range of less than 300 are ignored. That is, although the maximum peak in a molecular weight range of less than 300 may be present, the maximum peak described above is limited to the peak present in a molecular weight range of 300 or more.

Although measurement conditions of the GPC measurement in this embodiment are not particularly limited, the conditions described in Examples may be used, and the identification of the molecular weight can be performed using the standard polystyrenes.

As the specific silicone-based surfactant 2, for example, there may be mentioned a silicone-based surfactant in which a in the general formula (1) which will be described later is smaller than that of the specific silicone-based surfactant 1 contained in the chromatic ink composition. Alternatively, a silicone-based surfactant in which in the general formula (3) which will be described later, d+e is smaller than that of the specific silicone-based surfactant 1 may be mentioned. The specific silicone-based surfactant 2 has a relatively small molecular weight as compared to that of the specific silicone-based surfactant 1.

In addition, as the specific silicone-based surfactant 2, a commercially available product may also be used, and for example, BYK-349 (trade name, manufactured by BYK Japan KK, the maximum peak in a molecular weight range of 300 or more is located at 1,470 in a molecular weight distribution by a GPC measurement) may be mentioned.

When the specific silicone-based surfactant 2 is contained, a lower limit of a content thereof with respect to the total mass of the black ink composition is preferably 0.05 percent by mass or more, more preferably 0.1 percent by mass or more, even more preferably 0.2 percent by mass or more, further preferably 0.3 percent by mass or more, and particularly preferably 0.4 percent by mass or more. On the other hand, an upper limit of the content described above with respect to the total mass of the black ink composition is preferably 5.0 percent by mass or less, more preferably 2.0 percent by mass or less, even more preferably 1.0 percent by mass or less, further preferably 0.8 percent by mass or less, even further preferably 0.7 percent by mass or less, particularly preferably 0.6 percent by mass or less, more particularly preferably 0.5 percent by mass or less, and even more particularly preferably 0.3 percent by mass or less.

When the content of the specific silicone-based surfactant 2 is in the range described above, an excellent wet spreadability is obtained, and in addition, the prevention of inter-color mixing and the abrasion resistance tend to be made more excellent.

### 1.1.3.2. Other Surfactants

The black ink composition included in the ink set according to this embodiment may also contain a surfactant other than the specific silicone-based surfactant 2. As the surfactant other than the specific silicone-based surfactant 2, for example, the specific silicone-based surfactant 1 contained in the chromatic ink composition which will be described later, an acetylene glycol-based surfactant, a silicone-based surfactant (other than the specific silicone-based surfactants 1 and 2), and/or a fluorine-based surfactant may be mentioned.

When the black ink composition further contains a specific silicone-based surfactant 1, after the black ink composition wet-spreads, the fluidity of the black ink composition is decreased, and hence, the inter-color mixing between the inks tends to be further prevented. In addition, the specific silicone-based surfactant 1 may be the same as or different from the specific silicone-based surfactant 1 contained in the chromatic ink composition which will be described later.

A content of the specific silicone-based surfactant 1 with respect to the total mass of the black ink composition is preferably 5.0 percent by mass or less, more preferably 3.0 percent by mass or less, even more preferably 1.5 percent by mass or less, further preferably 1.0 percent by mass or less, even further preferably 0.5 percent by mass or less, particularly preferably 0.2 percent by mass or less, more particularly preferably 0.1 percent by mass or less, and even more particularly preferably 0.05 percent by mass or less. A lower limit of the content described above is preferably 0 percent by mass or more, more preferably 0.05 percent by mass or more, even more preferably 0.1 percent by mass or more, and further preferably 0.2 percent by mass or more.

When the content of the specific silicone-based surfactant 1 is in the range described above, the wet spreadability of the black ink composition and the prevention of inter-color mixing between the inks tend to be made excellent at the same time.

Although the acetylene glycol-based surfactant is not particularly limited, for example, there may be mentioned 2,4,7,9-tetramethyl-5-decyne-4,7-diol, an alkylene oxide adduct thereof, 2,4-dimethyl-5-decyne-4-ol, or an alkylene oxide adduct thereof.

As a commercially available product of the acetylene glycol-based surfactant, for example, there may be mentioned Surfynol 104, 104E, 104H, 104A, 104BC, 104DPM, 104PA, 104PG-50, 104S, 420, 440, 465, 485, SE, SE-F, 504, 61, DF37, CT111, CT121, CT131, CT136, TG, GA, or DF110D (trade name, manufactured by Air Products & Chemicals Inc.); Olfine B, Y, P, A, STG, SPC, E1004, E1010, PD-001, PD-002W, PD-003, PD-004, EXP.4001, EXP.4036, EXP.4051, AF-103, AF-104, AK-02, SK-14, or AE-3 (trade name, manufactured by Nisshin Chemical Industry Co., Ltd.); or Acetylenol E00, E00P, E40, or E100(trade name, manufactured by Kawaken Fine Chemicals Co., Ltd.).

Although the silicone-based surfactant other than the specific silicone-based surfactants 1 and 2 is not particularly limited, a polysiloxane-based compound may be mentioned. Although the polysiloxane-based compound is not particularly limited, for example, a polyether-modified organosiloxane is preferably mentioned. As a commercially available product of the polyether-modified organosiloxane, for example, SAG503A (trade name, manufactured by Nisshin Chemical Industry Co., Ltd., the maximum peak in a molecular weight range of 300 or more is located at 1,820 in a molecular weight distribution by a GPC measurement) may be mentioned. In addition, BYK-348 may also be mentioned.

Although the fluorine-based surfactant is not particularly limited, for example, there may be mentioned a perfluoroalkyl sulfonate salt, a perfluoroalkyl carboxylate salt, a perfluoroalkyl phosphate ester, a perfluoroalkyl ethylene oxide adduct, a perfluoroalkyl alkyl betaine, or a perfluoroalkylamine oxide compound.

As a commercially available product of the fluorine-based surfactant, for example, there may be mentioned BYK-3440 (trade name, manufactured by BYK Japan KK); Surflon S-241, S-242, or S-243 (trade name, manufactured by AGC Seimi Chemical Co., Ltd.); or Ftergent 215M (trade name, manufactured by Neos Co., Ltd.) may be mentioned.

In the black ink composition included in the ink set according to this embodiment, a lower limit of a total content of the silicone-based surfactant including the specific silicone-based surfactants 1 and 2 with respect to the total mass of the black ink composition is preferably 0 percent by mass or more, more preferably 0.1 percent by mass or more, even more preferably 0.2 percent by mass or more, further preferably 0.3 percent by mass or more, and particularly preferably 0.4 percent by mass or more. The lower limit described above may be 0 percent by mass. In addition, an upper limit of the content described above with respect to the total mass of the black ink composition is preferably 5.0 percent by mass or less, more preferably 2.0 percent by mass or less, even more preferably 1.0 percent by mass or less, further preferably 0.8 percent by mass or less, even further preferably 0.7 percent by mass or less, and particularly preferably 0.6 percent by mass or less.

In addition, a total content of the silicone-based surfactant in the chromatic ink composition which will be described later is preferably equal to or higher than the total content of the silicone-based surfactant in the black ink composition and is more preferably higher than that described above. When the relationship as described above is satisfied, the inter-color mixing between the inks tends to be further prevented.

Furthermore, the total content of the silicone-based surfactant in the chromatic ink composition is higher than the total content of the silicone-based surfactant in the black ink composition preferably by 0.1 percent by mass or more, more preferably by 0.2 to 4 percent by mass, and further preferably by 0.3 to 1 percent by mass.

### 1.1.4. Organic Solvent

The black ink composition included in the ink set according to this embodiment may contain an organic solvent. As the organic solvent, for example, a glycol monoether solvent and/or a solvent other than the glycol monoether solvent may be mentioned.

### 1.1.4.1. Glycol Monoether Solvent

The black ink composition included in the ink set according to this embodiment contains at least one selected from a glycol monoether solvent and the specific silicone-based surfactant 2 described above.

While the wet spreadability of the ink is enhanced, the glycol monoether solvent is also able to reduce the inter-color mixing between the inks. The reason for this is believed that because of an excellent permeability of the glycol monoether solvent, although the ink is allowed to wet-spread immediately after being landed on a recording medium, since the glycol monoether solvent is likely to evaporate thereon, the permeability is decreased after the evaporation, and as a result, the color mixing is not likely to occur. In addition, when the glycol monoether solvent is contained, the wet spreadability and the prevention of color mixing are not only made excellent, but the abrasion resistance also tends to be made more excellent since the glycol monoether solvent is likely to evaporate in a post-drying step which is a step to complete drying of a recorded matter.

In addition, as described above, the black ink composition included in the ink set according to this embodiment may contain both the glycol monoether solvent and the specific silicone-based surfactant 2 described above. In the case as described above, the wet spreadability, the abrasion resistance, and the prevention of inter-color mixing tend to be preferably adjusted with a good balance.

As the glycol monoether solvent, for example, a glycol monoether in which one hydroxy group of an alkane polyol which will be described later is etherified may be mentioned. By this etherification, for example, an alkyl ether or an aryl ether may be formed, and an alky ether is preferable.

The number of carbon atoms of an ether portion of the glycol monoether is preferably 1 to 12. In addition, the number of carbon atoms described above is preferably 5 or more or 2 or less. In the case described above, the image quality and the abrasion resistance are preferably made more excellent. In the case of the alkyl ether or the aryl ether, the ether portion is the portion of the alkyl or the aryl.

The ether portion of the glycol monoether is more preferably an alkyl ether portion, and the number of carbon atoms of the alkyl ether portion is 5 or more or 2 or less.

In the glycol monoether in which the number of carbon atoms of the alkyl ether portion is 5 or more, the number of carbon atoms of the alkyl ether portion is preferably 5 to 12, more preferably 6 to 10, and further preferably 7 to 9. When the number of carbon atoms of the alkyl ether potion of the glycol monoether is 5 or more and is more preferably in the range described above, the wet spreadability tends to be made particularly excellent.

As the glycol monoether in which the number of carbon atoms of the alkyl ether portion is 5 or more, for example, there may be mentioned 2-ethylhexyl diglycol (alias: diethylene glycol mono(2-ethylhexyl) ether, standard boiling point: 272° C.) or hexylene glycol (alias: diethylene glycol monohexyl ether, standard boiling point: 258° C.)

As the glycol monoether in which the number of carbon atoms of the alkyl ether portion is 2 or less, a glycol monoether in which the number of carbon atoms of the alkyl ether portion is 1 is more preferable. When the glycol monoether in which the number of carbon atoms of the alkyl ether portion is 2 or less and is more preferably 1 is used, the wet spreadability is made more excellent, and in addition, since the standard boiling point is relatively low, the abrasion resistance tends to be made more excellent.

As the glycol monoether in which the number of carbon atoms of the alkyl ether portion is 2 or less, for example, there may be mentioned 3-methoxy-1-butanol (standard boiling point: 158° C.) or 3-methoxy-3-methyl-1-butanol (standard boiling point: 174° C.)

Accordingly, when the black ink composition contains the glycol monoether solvent, and when the glycol monoether solvent includes an alkyl ether portion in which the number of carbon atoms is 5 or more or 2 or less or is preferably in the range described above, the wet spreadability and the abrasion resistance tend to be further improved.

The number of carbon atoms of the alkylene glycol portion of the glycol monoether is preferably 2 to 6, more preferably 2 to 5, further preferably 2 to 4, and particularly preferably 2 to 3.

In addition, the number of repetitions of the alkylene glycol portion is preferably 1 to 5, more preferably 1 to 4, and further preferably 1 to 3.

In addition, the “number of carbon atoms of the alkyl ether portion” indicates, for example, the number of carbon atoms of a portion represented by R⁷ in the following general formula (A) and indicates the number of carbon atoms of R⁷ of a terminal —OR⁷ portion of the glycol monoether. In addition, the “number of carbon atoms of the alkylene glycol portion” indicates, for example, the number of carbon atoms of a portion represented by R⁶ in the following general formula (A).

In addition, the glycol monoether solvent may be preferably a glycol monoether represented by the following general formula (A).

HO—(R⁶O)ₘ—R⁷ (A)

In the general formula (A), R⁶ represents an alkylene group having 2 to 6 carbon atoms, R⁷ represents an alkyl group having 5 or more or 2 or less, and m represents an integer of 1 to 4.

In the general formula (A) described above, the alkylene group R⁶ may be linear or branched, and the number of carbon atoms thereof is more preferably 2 to 5, further preferably 2 to 4, and particularly preferably 2 to 3. In addition, the alkyl group R⁷ having 5 carbon atoms or more may be linear or branched, and the number of carbon atoms thereof is preferably 5 to 12, more preferably 6 to 10, and further preferably 7 to 9. On the other hand, the number of carbon atoms of the alkyl group R⁷ having 2 carbon atoms or less is more preferably 1. In addition, m represents preferably an integer of 1 to 3 and more preferably an integer of 1 to 2.

As a concrete example of the glycol monoether solvent, for example, there may be mentioned 2-methoxyethanol (alias: ethylene glycol monomethyl ether), 2-ethoxyethanol (alias: ethylene glycol monoethyl ether), ethylene glycol monoisopropyl ether, ethylene glycol monobutyl ether, diethylene glycol monomethyl ether, diethylene glycol monoethyl ether, diethylene glycol monobutyl ether, triethylene glycol monomethyl ether, triethylene glycol monoethyl ether, triethylene glycol monobutyl ether (alias: butyl triglycol, standard boiling point: 278° C.), tetraethylene glycol monomethyl ether, tetraethylene glycol monoethyl ether, tetraethylene glycol monobutyl ether, 1-methoxy-2-propanol (alias: propylene glycol-1-monomethyl ether), 2-methoxypropanol (alias: propylene glycol-2-monomethyl ether), 1-ethoxy-2-propanol (alias: propylene glycol monoethyl ether), propylene glycol monopropyl ether, propylene glycol monobutyl ether, dipropylene glycol monomethyl ether, dipropylene glycol monoethyl ether, dipropylene glycol monopropyl ether, dipropylene glycol monobutyl ether, tripropylene glycol monobutyl ether, 3-methoxy-1-propanol (alias: 1,3-propanediol monomethyl ether), 1-methoxy-2-butanol (alias: 1,2-butanediol-1-monomethyl ether), 2-methoxy-1-butanol, 3-methoxy-1-butanol (alias: 1,3-butanediol-3-monomethyl ether, standard boiling point: 158° C.), 4-methoxy-1-butanol (alias: 1,4-butanediol monomethyl ether), 3-methoxy-3-methyl butanol, 2-ethylhexyl diglycol (alias: diethylene glycol-mono(2-ethylhexyl) ether, standard boiling point: 272° C.), or hexyl diglycol (alias: diethylene glycol monohexyl ether, standard boiling point: 258° C.)

When the glycol monoether solvent is contained, a content thereof with respect to the total mass of the black ink composition is preferably 5.0 percent by mass or less, more preferably 4.0 percent by mass or less, even more preferably 3.0 percent by mass or less, further preferably 2.0 percent by mass or less, and particularly preferably 1.5 percent by mass or less. In addition, the content described above is preferably 0.1 percent by mass or more, more preferably 0.3 percent by mass or more, even more preferably 0.5 percent by mass or more, further preferably 0.6 percent by mass or more, and particularly preferably 0.7 percent by mass or more.

When the content of the glycol monoether solvent is in the range described above and in particular, is 2.0 percent by mass or less, the abrasion resistance is made more excellent, and the inter-color mixing between the inks tends to be further reduced.

A standard boiling point of the glycol monoether solvent is preferably 300° C. or less, more preferably 100° C. to 280° C., even more preferably 110° C. to 270° C., further preferably 200° C. to 260° C., and even further preferably 220° C. to 250° C. Alternatively, the standard boiling point described above is preferably 120° C. to 250° C., more preferably 130° C. to 200° C., and further preferably 140° C. to 190° C. 1.1.4.2. OTHER ORGANIC SOLVENTS

The black ink composition included in the ink set according to this embodiment may contain at least one organic solvent (other organic solvents) other than the glycol monoether solvent described above. The other organic solvents are each preferably a water-soluble organic solvent.

As the other organic solvents, for example, there may be mentioned an alcohol, an alkane polyol, a glycol polyether, an ester, an amide, a sulfur-containing solvent, and/or a cyclic ether. The alkane polyol may include an alkanediol. The organic solvents are not limited to those mentioned above.

As the alcohol, for example, a compound in which one hydrogen atom of an alkane is replaced by a hydroxy group may be mentioned. As the alkane, an alkane having 10 carbon atoms or less is preferable, an alkane having 6 carbon atoms or less is more preferable, and an alkane having 3 carbon atoms or less is further preferable. The number of carbon atoms of the alkane is one or more and is preferably two or more. The alkane may be either linear or branched. As the alcohol, for example, there may be mentioned methanol, ethanol, n-propyl alcohol, iso-propyl alcohol, n-butanol, 2-butanol, tert-butanol, iso-butanol, n-pentanol, 2-pentanol, 3-pentanol, or tert-pentanol.

As the alkanediol, for example, a compound in which an alkane is replaced by two hydroxy groups may be mentioned. As the alkanediol, for example, there may be mentioned ethylene glycol (alias: ethane-1,2-diol), propylene glycol (alias: propane-1,2-diol, standard boiling point: 188° C.), 1,2-butanediol (standard boiling point: 193° C.), 1,2-pentanediol, 1,2-hexanediol (standard boiling point: 223° C.), 1,2-octanediol, 1,3-propanediol, 1,3-butylene glycol (alias: 1,3-butanediol, standard boiling point: 207° C.)), 1,4-butanediol, 2,3-butanediol, 1,2-pentanediol, 1,5-pentanediol (standard boiling point: 239° C.), 2,4-pentanediol, 2-methyl-1,3-propanediol, 3-methyl-1,3-butanediol (alias: isoprene glycol), 3-methyl-1,5-pentanediol, 2-ethyl-1,3-hexanediol, 3-methyl-1,5-pentanediol, 2-methylpentane-2,4-diol (alias: hexylene glycol), 1,6-hexanediol, 2-ethyl-2-methyl-1,3-propanediol, or 2-methyl-2-propyl-1,3-propanediol.

As the alkane polyol, for example, an alkanediol, a condensate in which at least two alkanediol molecules are intermolecular condensed between hydroxy groups, or an alkane having at least three hydroxy groups may be mentioned. The alkanediol mentioned above is also included in the alkane polyol. The alkane polyol has at least two hydroxy groups in its molecule.

As the condensate in which at least two alkanediol molecules are intermolecular condensed between hydroxy groups, for example, there may be mentioned a dialkylene glycol, such as diethylene glycol or dipropylene glycol, or a trialkylene glycol, such as triethylene glycol or tripropylene glycol.

The alkane having at least three hydroxy groups is a compound which has at least three hydroxy groups and a skeleton of an alkane, a polyol having a polyether structure, or the like. For example, a compound in which an alkane or a polyol having a polyether structure is replaced by at least three hydroxy groups may be mentioned.

As the alkane having at least three hydroxy groups, for example, there may be mentioned glycerin (standard boiling point: 290° C.), trimethylolethane, trimethylolpropane, 1,2,5-hexanetriol, 1,2,6-hexanetriol, pentaerythritol, or a polyoxypropylene triol.

As the glycol polyether, for example, a compound in which at least two hydroxy groups of the alkane polyol mentioned above are etherified may be mentioned, and for example, a glycol diether in which two hydroxy groups are etherified may be mentioned. A compound having no hydroxy groups in its molecule is preferable.

By the etherification, for example, an alkyl ether or an aryl ether may be formed, and an alkyl ether is preferably formed. The number of carbon atoms of an ether portion formed by the etherification is preferably 1 to 8 and more preferably 1 to 4. The number of carbon atoms of an alkylene glycol portion of the glycol polyether is preferably 2 to 6. The number of repetitions of the alkylene glycol portion is preferably 1 to 5.

As a concrete example of a glycol diether, for example, there may be mentioned ethylene glycol dimethyl ether, ethylene glycol diethyl ether, ethylene glycol dibutyl ether, diethylene glycol dimethyl ether, diethylene glycol diethyl ether, diethylene glycol dibutyl ether, diethylene glycol methyl ethyl ether, diethylene glycol methyl butyl ether, triethylene glycol dimethyl ether, triethylene glycol diethyl ether, triethylene glycol dibutyl ether, triethylene glycol methyl butyl ether, tetraethylene glycol dimethyl ether, tetraethylene glycol diethyl ether, tetraethylene glycol dibutyl ether, propylene glycol dimethyl ether, propylene glycol diethyl ether, dipropylene glycol dimethyl ether, dipropylene glycol diethyl ether, or tripropylene glycol dimethyl ether.

As the ester, for example, an acyclic ester or a cyclic ester may be mentioned.

As the acyclic ester, for example, there may be mentioned a glycol monoacetate, such as ethylene glycol monomethyl ether acetate, ethylene glycol monoethyl ether acetate, ethylene glycol monobutyl ether acetate, diethylene glycol monomethyl ether acetate, diethylene glycol monoethyl ether acetate, diethylene glycol monobutyl ether acetate, propylene glycol monomethyl ether acetate, dipropylene glycol monomethyl ether acetate, or methoxybutyl acetate; or a glycol diester, such as ethylene glycol diacetate, diethylene glycol diacetate, propylene glycol diacetate, dipropylene glycol diacetate, ethylene glycol acetate propionate, ethylene glycol acetate butyrate, diethylene glycol acetate butyrate, diethylene glycol acetate propionate, propylene glycol acetate propionate, propylene glycol acetate butyrate, dipropylene glycol acetate butyrate, or dipropylene glycol acetate propionate.

As the cyclic ester, for example, there may be mentioned a cyclic ester (lactone), such as β-propiolactone, γ-butyrolactone, δ-valerolactone, ε-caprolactone, β-butyrolactone, β-valerolactone, γ-valerolactone, β-hexanolactone, γ-hexanolactone, δ-hexanolactone, β-heptanolactone, γ-heptanolactone, δ-heptanolactone, ε-heptanolactone, γ-octanolactone, δ-octanolactone, ε-octanolactone, δ-nonalactone, ε-nonalactone, or ε-decanolactone; or a compound in which a hydrogen atom of a methylene group adjacent to a carbonyl group of one of those mentioned above is replaced by an alkyl group having 1 to 4 carbon atoms.

As the amide, for example, a cyclic amide or an acyclic amide may be mentioned. As the acyclic amide, for example, an alkoxyalkylamide may be mentioned.

As the cyclic amide, a lactam may be mentioned, and for example, there may be mentioned a pyrrolidone, such as 2-pyrrolidone (standard boiling point: 245° C.), 1-methyl-2-pyrrolidone, 1-ethyl-2-pyrrolidone, 1-propyl-2-pyrrolidone, or 1-butyl-2-pyrrolidone; 2-piperidone, ε-caprolactam, N-methyl-ε-caprolactam, N-cyclohexyl-2-pyrrolidone, 5-methyl-2-pyrrolidone, β-propiolactam, ω-heptalactam, or succinimide. Among those mentioned above, in particular, 2-pyrrolidone or ε-caprolactam is more preferable.

As the acyclic amide, for example, there may be mentioned an alkoxyalkylamide, such as 3-methoxy-N,N-dimethylpropionamide, 3-methoxy-N,N-diethylpropionamide, 3-methoxy-N, N-methylethylpropionamide, 3-ethoxy-N,N-dimethylpropionamide, 3-ethoxy-N,N-diethylpropionamide, 3-ethoxy-N,N-methylethylpropionamide, 3-n-butoxy-N,N-dimethylpropionamide, 3-n-butoxy-N,N-diethylpropionamide, 3-n-butoxy-N,N-methylethylpropionamide, 3-n-propoxy-N,N-dimethylpropionamide, 3-n-propoxy-N,N-diethylpropionamide, 3-n-prooxy-N,N-methylethylpropionamide, 3-iso-propoxy-N,N-dimethylpropionamide, 3-iso-propoxy-N,N-diethylpropionamide, 3-iso-prooxy-N,N-methylethylpropionamide, 3-tert-butoxy-N,N-dimethylpropionamide, 3-tert-butoxy-N,N-diethylpropionamide, or 3-tert-butoxy-N,N-methylethylpropionamide; or N,N-dimethylacetoacetamide, N,N-diethylacetoacetamide, N-methylacetoacetamide, N,N-dimethylisobutyramide, N,N-dimethylformamide, N,N-diethylformamide, N,N-dimethylacetamide, N,N-diethylacetamide, or N,N-dimethylpropionamide.

As the sulfur-containing solvent, for example, there may be mentioned a sulfoxide or a sulfone. As the sulfoxide, for example, there may be mentioned an acyclic sulfoxide, such as dimethyl sulfoxide or diethyl sulfoxide; or a cyclic sulfoxide, such as tetramethylene sulfoxide. As the sulfone, for example, there may be mentioned a cyclic sulfone, such as 3-methylsulfolane or sulfolane; or an acyclic sulfone, such as ethyl isopropyl sulfone, ethyl methyl sulfone, or dimethyl sulfone.

As the cyclic ether, for example, there may be mentioned tetrahydrofuran, 1,4-dioxane, dimethylisosorbide, 3-methyl-3-oxetanemethanol, 3-ethyl-3-oxetanemethanol, 2-hydroxymethyloxetane, tetrahydrofurfuryl alcohol, glycerol formal, solketal, 1,4-dioxane-2,3-diol, or dihydrolevoglucosenone.

Those organic solvents may be used alone, or at least two types thereof may be used in combination.

The standard boiling point of the organic solvent is preferably 300° C. or less, more preferably 280° C. or less, even more preferably 270° C. or less, further preferably 250° C. or less, even further preferably 210° C. or less, particularly preferably 200° C. or less, and more particularly preferably 190° C. or less. In addition, although a lower limit of the standard boiling point of the organic solvent is not particularly limited, the lower limit described above is preferably 100° C. or more, more preferably 110° C. or more, even more preferably 120° C. or more, and further preferably 150° C. or more.

As one embodiment of the ink set according to this embodiment, in each of the black ink composition and the chromatic ink composition which will be described later, an organic solvent is contained, and a content of an organic solvent having a standard boiling point of less than 200° C. with respect to total 100 parts by mass of the organic solvent is preferably 50 parts by mass or more, more preferably 60 parts by mass or more, further preferably 70 parts by mass or more, and particularly preferably 75 parts by mass or more. Although an upper limit of the content described above is not particularly limited, the upper limit described above is preferably 100 parts by mass or less, more preferably 90 parts by mass or less, and further preferably 85 parts by mass or less.

In addition, in the one embodiment described above, the standard boiling point of the organic solvent is more preferably less than 195° C. and further preferably less than 190° C.

In the black ink composition and the chromatic ink composition, when the content of the organic solvent having a standard boiling point of less than 200° C. is in the range described above, the drying property is made more excellent, and the abrasion resistance tends to be made more excellent.

As one embodiment of the ink set according to this embodiment, in each of the black ink composition and the chromatic ink composition which will be described later, an organic solvent is contained, and a content of the organic solvent with respect to the total mass of the ink composition is preferably 1 to 40 percent by mass, more preferably 5 to 30 percent by mass, even more preferably 8 to 28 percent by mass, further preferably 12 to 26 percent by mass, even further preferably 15 to 24 percent by mass, and particularly preferably 17 to 22 percent by mass.

When the content of the organic solvent in each of the black ink composition and the chromatic ink composition is in the range described above, the abrasion resistance is made more excellent, and in addition, the inter-color mixing tends to be further reduced.

As one embodiment of the ink set according to this embodiment, in each of the black ink composition and the chromatic ink composition which will be described later, at least one organic solvent is contained, and a standard boiling point of an organic solvent having the highest standard boiling point among the organic solvents contained in the ink composition is preferably 300° C. or less, more preferably 270° C. or less, even more preferably 250° C. or less, further preferably 230° C. or less, even further preferably 220° C. or less, particularly preferably 210° C. or less, more particularly preferably 200° C. or less, and even more particularly preferably 190° C. or less.

Among the organic solvents contained in each of the black ink composition and the chromatic ink composition, when the standard boiling point of the organic solvent having the highest standard boiling point is in the range described above, the drying property is made more excellent, and the abrasion resistance tends to be made more excellent.

As one embodiment of the ink set according to this embodiment, in each of the black ink composition and the chromatic ink composition which will be described later, an organic solvent which is an alkane polyol having a standard boiling point of more than 280° C. is not contained preferably at a content of more than 3 percent by mass, more preferably at a content of more than 2 percent by mass, even more preferably at a content of more than 1 percent by mass, further preferably at a content of more than 0.5 percent by mass, and even further preferably at a content of more than 0.1 percent by mass and is particularly preferably not contained (0 percent by mass).

When the content of the organic solvent which is an alkane polyol having a standard boiling point of more than 280° C. in each of the black ink composition and the chromatic ink composition is in the range described above, the drying property of the recorded matter is made more excellent, and the abrasion resistance tends to be further improved.

### 1.1.5. Fixing Resin

In view of improvement in abrasion resistance, the black ink composition included in the ink set according to this embodiment may further contain a fixing resin. The fixing resin indicates a resin having a function to improve glossiness, adhesion, aging stability, and the like of a recorded image. The fixing resin is preferably in the form of an emulsion or a powder, that is, is preferably contained in the form of resin particles in the ink.

Although the resin particles are not particularly limited, for example, resin particles formed from an urethane-based resin, an acrylic-based resin (including a styrene-acrylic-based resin), a fluorene-based resin, a polyolefin-based resin, a rosin-modified resin, a terpene-based resin, a polyester-based resin, a polyamide-based resin, an epoxy-based resin, a vinyl chloride-based resin, a vinyl chloride-vinyl acetate copolymer, or an ethylene-vinyl acetate-based resin may be mentioned.

The urethane-based resin is a generic name of a resin having an urethane bond. As the urethane-based resin, for example, a polyether type urethane resin having an ether bond in its main chain besides the urethane bond, a polyester type urethane resin having an ester bond in its main chain besides the urethane bond, or a polycarbonate type urethane resin having a carbonate bond in its main chain besides the urethane bond may be used.

The acrylic-based resin is a generic name of a polymer obtained by polymerization using at least an acrylic-based monomer, such as (meth)acrylic acid or a (meth)acrylate ester, as one component, and for example, a resin obtained from an acrylic-based monomer or a copolymer between an acrylic-based monomer and a monomer other than that may be mentioned. For example, an acrylic vinyl-based resin which is a copolymer between an acrylic-based monomer and a vinyl-based monomer may be mentioned. In addition, as the vinyl-based monomer, for example, styrene may be mentioned. As the acrylic-based monomer, for example, acrylamide or acrylonitrile may also be used. In addition, in this specification, (meth)acryl indicates acryl and/or methacryl.

The polyolefin-based resin is a resin having a structural skeleton of an olefin, such as ethylene, propylene, or butylene, and a known resin may be appropriately and selectively used.

As the resin particles, one type may be used alone, or at least two types thereof may be used in combination.

Among those mentioned above, acrylic-based resin particles, urethane-based resin particles, or polyester-based resin particles are preferably mentioned. Since those resin particles are used, the abrasion resistance tends to be further improved. Although being frequently handled in the form of an emulsion, those resin particles may also be in the form of a powder.

As the resin particles, the acrylic-based resin is particularly preferable, and a styrene-acrylic-based resin is more preferable. Although the styrene-acrylic-based resin is not particularly limited, for example, there may be mentioned a styrene-acrylic acid copolymer, a styrene-methacrylic acid copolymer, a styrene-methacrylic acid-acrylate ester copolymer, a styrene-α-methylstyrene-acrylic acid copolymer, or a styrene-α-methylstyrene-acrylic acid-acrylate ester copolymer. When those resins are used, the abrasion resistance of a recorded matter to be obtained tends to be further improved.

A content of the resin particles with respect to the total mass of the black ink composition is preferably 0.5 to 6.0 percent by mass, more preferably 1.0 to 5.0 percent by mass, and further preferably 2.0 to 4.0 percent by mass. When the content of the resin particles is in the range described above, the abrasion resistance tends to be further improved.

### 1.1.6. Wax

In view of improvement in abrasion resistance, the black ink composition included in the ink set according to this embodiment may further contain a wax.

Although the wax is not particularly limited, for example, there may be mentioned a hydrocarbon wax or an ester wax which is a condensate between an aliphatic acid and a monovalent alcohol or a polyvalent alcohol. Although the hydrocarbon wax is not particularly limited, for example, a paraffin wax or a polyolefin wax, such as a polyethylene wax or a polypropylene wax, may be mentioned. Those waxes may be used alone, or at least two types thereof may be used in combination. Among those waxes, in view of improvement in abrasion resistance, a hydrocarbon wax is preferable, a polyolefin wax is more preferable, and a polyethylene wax is further preferable.

The wax may be, for example, in the form of an emulsion in which wax particles are dispersed in water.

A content of the wax with respect to the total mass of the black ink composition is preferably 0.1 to 5.0 percent by mass, more preferably 0.3 to 3.0 percent by mass, and further preferably 0.6 to 1.5 percent by mass. Accordingly, the abrasion resistance of a recorded matter to be obtained tends to be further improved.

### 1.1.7. Other Components

In the black ink composition included in the ink set according to this embodiment, various additives, such as a solubilizing agent, a viscosity adjuster, a pH adjuster, an antioxidant, an antiseptic agent, a fungicide, a corrosion inhibitor, and/or a chelating agent, may be appropriately added.

### 1.2. Chromatic Ink Composition

The chromatic ink composition included in the ink set according to this embodiment is a water-based ink jet ink and contains at least a colorant and the specific silicone-based surfactant 1. In addition, as components of the chromatic ink composition other than the colorant and the specific silicone-based surfactant 1, besides the components which will be described later, for example, components similar to the components which are allowed to be contained in the black ink composition described above may be also preferably contained at contents similar to those described above.

The “chromatic color” in the present disclosure indicates a color tone, such as cyan, magenta, yellow, red, green, orange, or blue. In the CIE L*a*b* color space, a color having predetermined a* and b* values or more and having the hue and the saturation may be mentioned.

On the other hand, the “achromatic color” indicates a color tone to be recognized as a black color or a white color. A color having neither hue nor saturation may be mentioned.

### 1.2.1. Colorant

The chromatic ink composition included in the ink set according to this embodiment contains a colorant. As the colorant, both a pigment and a dye may be used, and for example, an inorganic pigment, such as titanium white, an organic pigment, an oil soluble dye, an acidic dye, a direct dye, a reactive dye, a basic dye, a dispersive dye, or a sublimation dye may be used. In addition, the black colorants described above may also be used if needed.

As the inorganic pigment other than the black pigments described above, for example, an iron oxide, a titanium oxide, a zinc oxide, or a silica may be mentioned.

As the organic pigment, for example, there may be mentioned a quinacridone-based pigment, a quinacridonequinone-based pigment, a dioxazine-based pigment, a phthalocyanine-based pigment, an anthrapyrimidine-based pigment, an anthanthrone-based pigment, an indanthrone-based pigment, a flavanthrone-based pigment, a perylene-based pigment, a diketopyrrolopyrrole-based pigment, a perinone-based pigment, a quinophthalone-based pigment, an anthraquinone-based pigment, a thioindigo-based pigment, a benzimidazolone-based pigment, an isoindolinone-based pigment, an azomethine-based pigment, or an azo-based pigment.

As a concrete example of the organic pigment, the following may be mentioned.

As a cyan pigment, for example, C.I. Pigment Blue 1, 2, 3, 15:3, 15:4, 15:34, 16, 22, or 60; or C.I. Vat Blue 4 or 60 may be mentioned, and for example, one selected from the group consisting of C.I. Pigment Blue 15:3, 15:4, and 60 or a mixture containing at least two types thereof may be preferably mentioned.

As a magenta pigment, for example, C.I. Pigment Red 5, 7, 12, 48(Ca), 48(Mn), 57(Ca), 57:1, 112, 122, 123, 168, 184, 202, or 209 or C.I. Pigment Violet 19 may be mentioned, and for example, one selected from the group consisting of C.I. Pigment Red 122, 202, and 209, and C.I. Pigment Violet 19 or a mixture containing at least two types thereof may be preferably mentioned.

As a yellow pigment, for example, C.I. Pigment Yellow 1, 2, 3, 12, 13, 14C, 16, 17, 73, 74, 75, 83, 93, 95, 97, 98, 119, 110, 114, 128, 129, 138, 150, 151, 154, 155, 180, or 185 may be mentioned, and for example, one selected from the group consisting of C.I. Pigment Yellow 74, 109, 110, 128, 138, 150, and 180 or a mixture containing at least two types thereof may be preferably mentioned.

Pigments other than those mentioned above may also be used. For example, an orange pigment and/or a green pigment may be mentioned.

As the dye other than the black dyes mentioned above, for example, C.I. Acid Yellow 17, 23, 42, 44, 79, or 142, C.I. Acid Red 52, 80, 82, 249, 254, or 289, C.I. Acid Blue 9, 45, or 249, C.I. Direct Yellow 1, 12, 24, 33, 50, 55, 58, 86, 132, 142, 144, or 173, C.I. Direct Red 1, 4, 9, 80, 81, 132, 225, or 227, C.I. Direct Blue 1, 2, 15, 71, 86, 87, 98, 165, 199, or 202, or C.I. Reactive Red 14, 32, 55, 79, 141, or 249.

Although a content of the colorant can be appropriately adjusted in accordance with application, the content described above with respect to a total mass of the chromatic ink composition is preferably 0.1 to 17.0 percent by mass, more preferably 0.2 to 15.0 percent by mass, even more preferably 1.0 to 10.0 percent by mass, and further preferably 2.0 to 5.0 percent by mass.

### 1.2.2. Water

The chromatic ink composition included in the ink set according to this embodiment is a water-based ink jet ink and contains water.

A content of the water with respect to the total mass of the chromatic ink composition is preferably 40 percent by mass or more, more preferably 45 percent by mass or more, even more preferably 50 percent by mass or more, further preferably 55 percent by mass or more, even further preferably 60 percent by mass or more, and particularly preferably 65 percent by mass or more. In addition, although an upper limit of the content of the water is not particularly limited, the upper limit described above with respect to the total mass of the chromatic ink composition is preferably 90 percent by mass or less and more preferably 80 percent by mass or less.

### 1.2.3. Surfactant

The chromatic ink composition included in the ink set according to this embodiment contain a silicone-based surfactant 1 (specific silicone-based surfactant 1) in which in a molecular weight distribution by a gel permeation chromatography, the maximum peak in a molecular weight range of 300 or more is located in a range of 3,000 to 20,000.

When the chromatic ink composition contains the specific silicone-based surfactant 1, the inter-color mixing between the black ink composition and the chromatic ink composition can be significantly reduced. Although the reason for this is believed that since the specific silicone-based surfactant 1 has a relatively high molecular weight, an ink droplet containing the component described above has a function to block intrusion of another ink droplet, the reason is not limited thereto. In addition, aggregation irregularity of the image can also be preferably suppressed.

In particular, when the black ink composition described above is a composition containing the specific silicone-based surfactant 2 described above, the inter-color mixing between the black ink composition and the chromatic ink composition preferably tends to be further suppressed.

### 1.2.3.1. Specific Silicone-Based Surfactant 1

The maximum peak of the specific silicone-based surfactant 1 in a molecular weight range of 300 or more is located at a molecular weight of 3,000 to 20,000, preferably at a molecular weight of 4,000 to 15,000, and more preferably at a molecular weight of 5,000 to 10,000. Since the maximum peak in a molecular weight range of 300 or more is located at a molecular weight of 3,000 or more, the inter-color mixing between the black ink composition and chromatic ink composition is suppressed, and the image quality (boundary bleeding) tends to be further improved. Since the maximum peak in a molecular weight range of 300 or more is located at a molecular weight of 20,000 or less, an ejection stability tends to be further improved.

Although the specific silicone-based surfactant 1 is not particularly limited, for example, a polysiloxane-based compound, such as dimethylsiloxane, methylphenylsiloxane, or diphenylsiloxane, may be mentioned, and those polysiloxane compounds each may be a modified organosiloxane in which a terminal end or a side chain group is modified by a polyether group or the like. Those specific silicone-based surfactants 1 may be used alone, or at least two types thereof may be used in combination.

Among those mentioned above, as the specific silicone-based surfactant 1, a modified organosiloxane is preferable, and a polyether-modified organosiloxane is more preferable. As the polyether-modified organosiloxane, there may be mentioned a modified organosiloxane represented by the following general formula (1) in which the terminal ends are each modified by a polyether group or a modified organosiloxane represented by the following general formula (3) in which the side chains are each modified by a polyether group. Since the specific silicone-based surfactant 1 as described above is used, the inter-color mixing between the black ink composition and the chromatic ink composition tends to be further suppressed. In particular, among the specific silicone-based surfactants 1, the modified organosiloxane represented by the following general formula (1) in which the terminal end is modified by a polyether group is preferable since the inter-color mixing between the inks and the aggregation irregularity are more significantly suppressed.

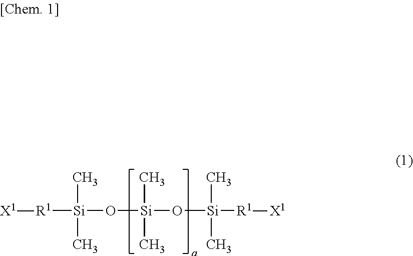

In the general formula (1), R¹'s each independently represent an alkylene group having 1 to 6 carbon atoms or a single bond, X¹'s each independently represent a polyether group represented by the following general formula (2), and a represents an integer of 10 to 80.

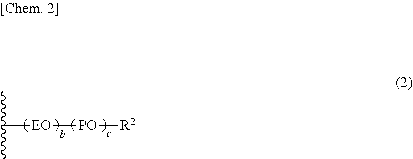

In the general formula (2), R² represents a hydrogen atom, an alkyl group having 1 to 6 carbon atoms, or a (meth)acrylic group, EO represents an ethylene oxide group, PO represents a propylene oxide group, the order of (EO)_{b}, and (PO)_{c} is an arbitrary order, b represents an integer of 0 or more, c represents an integer of 0 or more, and b+c represents an integer of 1 or more.

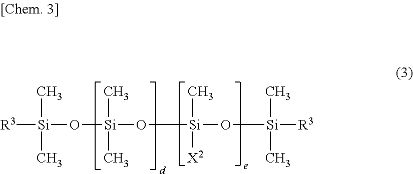

In the general formula (3), R³'s each independently represent an alkyl group having 1 to 6 carbon atoms, X²'s each independently represent a polyether group represented by the following general formula (4), d and e each represent an integer of 1 or more, and d+e represents an integer of 2 to 50.

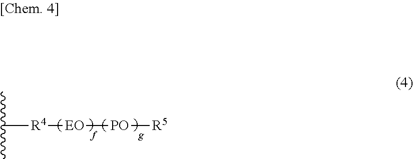

In the general formula (4), R4 represent an alkylene group having 1 to 6 carbon atoms or a single bond, R5 represent a hydrogen atom or an alkyl group having 1 to 6, EO represents an ethylene oxide group, PO represents a propylene oxide group, the order of (EO)_{f} and (PO)_{g} is an arbitrary order, f represents an integer of 0 or more, g represents an integer of 0 or more, and f+g represents an integer of 1 or more.

Although the alkylene groups having 1 to 6 carbon atoms represented by R¹, R³, and R⁴ are not particularly limited, for example, a methylene group, an ethylene group, a propylene group, a butylene group, a pentylene group, and/or a hexylene group may be mentioned. R¹ and R⁴ each preferably represent an alkylene group having 1 to 6 carbon atoms.

Although the alkyl groups having 1 to 6 carbon atoms represented by R² and R⁵ are not particularly limited, for example, a methyl group, an ethyl group, an n-propyl group, an isopropyl group, an n-butyl group, an isobutyl group, a sec-butyl group, a t-butyl group, an n-pentyl group, a neo-pentyl group, and/or an n-hexyl group may be mentioned.

R¹ and R⁴ each may also represent a single bond. The single bond indicates that an atom located at a right side of R¹ or R⁴ and an atom located at a left side thereof are directly bonded to each other by a single bond.

In the above general formulas (1) and (2), a is an integer of 10 to 80, preferably an integer of 20 to 70, and more preferably an integer of 30 to 60. In addition, b is an integer of 0 or more, preferably an integer of 2 to 30, and more preferably an integer of 5 to 20. Furthermore, c is an integer of 0 or more, preferably an integer of 0 to 30, and more preferably an integer of 0 to 20. In addition, b+c is an integer of 1 or more, preferably an integer of 1 to 60, more preferably an integer of 2 to 40, and further preferably an integer of 5 to 20.

In the above general formulas (3) and (4), d and e are each an integer of 1 or more, preferably an integer of 5 to 40, and more preferably an integer of 10 to 20. In addition, d+e is an integer of 2 to 50, preferably an integer of 5 to 40, and more preferably an integer of 10 to 30. Furthermore, f is an integer of 0 or more, preferably an integer of 1 or more, more preferably an integer of 2 to 30, and further preferably an integer of 5 to 20. Furthermore, g is an integer of 0 or more, preferably an integer of 0 to 30, and more preferably an integer of 0 to 20. In addition, f+g is an integer of 1 or more, preferably an integer of 1 to 60, more preferably an integer of 2 to 40, and further preferably an integer of 5 to 20.

In addition, as the specific silicone-based surfactant 1, a commercially available product may also be used, and for example, there may be mentioned BYK-333 (trade name, manufactured by BYK Japan KK, the maximum peak in a molecular weight range of 300 or more is located at 6,760 in a molecular weight distribution by a GPC measurement) or BYK-3480 (trade name, manufactured by BYK Japan KK, the maximum peak in a molecular weight range of 300 or more is located at 4,330 in a molecular weight distribution by a GPC measurement).

A content of the specific silicone-based surfactant 1 with respect to the total mass of the chromatic ink composition is preferably 0.05 percent by mass or more, more preferably 0.1 percent by mass or more, even more preferably 0.2 percent by mass or more, further preferably 0.3 percent by mass or more, and particularly preferably 0.4 percent by mass or more. On the other hand, the content described above with respect to the total mass of the chromatic ink composition is preferably 5.0 percent by mass or less, more preferably 2.0 percent by mass or less, even more preferably 1.0 percent by mass or less, further preferably 0.8 percent by mass or less, even further preferably 0.7 percent by mass or less, and particularly preferably 0.6 percent by mass or less. Furthermore, the content described above is preferably 0.5 percent by mass or less, more preferably 0.3 percent by mass or less, and further preferably 0.2 percent by mass or less.

When the content of the specific silicone-based surfactant 1 in the chromatic ink composition is in the range described above, the prevention of the inter-color mixing between the inks and the image quality of the chromatic ink composition tend to be improved with a good balance.

### 1.2.3.2. Other Surfactants

The chromatic ink composition included in the ink set according to this embodiment may contain a surfactant other than the specific silicone-based surfactant 1 described above. As the surfactant described above, the surfactant which can be contained in the black ink composition described above may be mentioned, and in particular, for example, a specific silicone-based surfactant 2 may be mentioned. In addition, the specific silicone-based surfactant 2 mentioned above may be the same as or different from the specific silicone-based surfactant 2 which can be contained in the black ink composition described above.

In the chromatic ink composition, a content of the specific silicone-based surfactant 2 with respect to the ink is 0 percent by mass or more, preferably 0.05 percent by mass or more, more preferably 0.1 percent by mass or more, even more preferably 0.2 percent by mass or more, further preferably 0.3 percent by mass or more, and particularly preferably 0.4 percent by mass or more. In addition, an upper limit of the content described above with respect to the total mass of the chromatic ink composition is preferably 5.0 percent by mass or less, more preferably 2.0 percent by mass or less, even more preferably 1.0 percent by mass or less, further preferably 0.8 percent by mass or less, and even further preferably 0.7 percent by mass or less, and particularly preferably 0.6 percent by mass or more. Furthermore, the upper limit described above is preferably 0.5 percent by mass or less, more preferably 0.3 percent by mass or less, even more preferably 0.1 percent by mass or less, and further preferably 0.05 percent by mass or less.

In addition, the chromatic ink composition preferably contains no specific silicone-based surfactant 2.

When the content of the specific silicone-based surfactant 2 is in the range described above, the chromatic ink composition tends to have a preferable wet spreadability.

In the chromatic ink composition included in the ink set according to this embodiment, a lower limit of the content in total of the silicone-based surfactant including the specific silicone-based surfactants 1 and 2 with respect to the total mass of the chromatic ink composition is preferably 0.05 percent by mass or more, more preferably 0.1 percent by mass or more, even more preferably 0.3 percent by mass or more, further preferably 0.5 percent by mass or more, even further preferably 0.8 percent by mass or more, particularly preferably 1.0 percent by mass or more, and more particularly preferably 1.3 percent by mass or more. In addition, an upper limit of the content described above with respect to the total mass of the chromatic ink composition is preferably 6.0 percent by mass or less, more preferably 4.0 percent by mass or less, even more preferably 2.0 percent by mass or less, further preferably 1.7 percent by mass or less, even further preferably 1.5 percent by mass or less, and particularly preferably 1.3 percent by mass or less.

In addition, a total content of the silicone-based surfactant in the chromatic ink composition is preferably higher than the total content of the silicone-based surfactant in the black ink composition. When the relationship as described above is satisfied, the inter-color mixing between the inks tends to be further prevented.

### 1.2.4. Organic Solvent

The chromatic ink composition included in the ink set according to this embodiment may contain an organic solvent. Although the type, the content, and the like of the organic solvent to be used may be set similar to those of the organic solvent of the black ink composition described above, it should be noted that the organic solvent can be prepared independently of that of the black ink composition.

The chromatic ink composition particularly preferably contains a glycol monoether solvent. Since the glycol monoether solvent is contained, while the wet spreadability of the ink is enhanced, the inter-color mixing between the inks is further reduced, and the abrasion resistance also tends to be made excellent.

A content of the glycol monoether solvent with respect to the total mass of the chromatic ink composition is preferably 5.0 percent by mass or less, more preferably 4.0 percent by mass or less, even more preferably 3.0 percent by mass or less, further preferably 2.0 percent by mass or less, and particularly preferably 1.5 percent by mass or less. In addition, the content described above is preferably 0.1 percent by mass or more, more preferably 0.3 percent by mass or more, further preferably 0.5 percent by mass or more, even further preferably 0.6 percent by mass or more, and particularly preferably 0.7 percent by mass or more.

When the content of the glycol monoether solvent is in the range described above and in particular, is 2.0 percent by mass or less, the abrasion resistance is made more excellent, and the inter-color mixing between the inks tends to be further reduced.

### 1.2.5. Fixing Resin

The chromatic ink composition included in the ink set according to this embodiment may contain a fixing resin. Although the type, the content, and the like of the fixing resin to be used may be set similar to those of the fixing resin of the black ink composition described above, it should be noted that the fixing resin can be prepared independently of that of the black ink composition.

### 1.2.6. Wax

The chromatic ink composition included in the ink set according to this embodiment may contain a wax. Although the type, the content, and the like of the wax to be used may be set similar to those of the wax of the black ink composition described above, it should be noted that the wax can be prepared independently of that of the black ink composition.

### 1.2.7. Other Components

In the chromatic ink composition included in the ink set according to this embodiment, various types of additives, such as a solubilizing agent, a viscosity adjuster, a pH adjuster, an antioxidant, an antiseptic agent, a fungicide, a corrosion inhibitor, and/or a chelating agent, may be appropriately added.

### 1.3. Preparation Method of Ink Composition

Although preparation methods of the black ink composition and the chromatic ink composition are not particularly limited, for example, a method in which the components described above are mixed together and are then sufficiently stirred so as to be uniformly mixed together may be mentioned.

### 1.4. Application

The ink set according to this embodiment is used for recording on a low-absorbing recording medium or a non-absorbing recording medium. In addition, a recording method which will be described later can be applied to various recording modes.

The non-absorbing recording medium or the low-absorbing recording medium indicates a recording medium absorbing no liquid or a recording medium absorbing almost no liquid, respectively. From a quantitative point of view, the non-absorbing recording medium or the low-absorbing recording medium indicates a recording medium having a water absorbing amount of 10 mL/m² or less from a contact start to a point of 30 msec^{1/2} by Bristow method. This Bristow method is a most popular measurement method of a liquid absorption amount in a short time and has also been employed by Japan Technical Association of the Pulp and Paper Industry (JAPAN TAPPI).

The details of the test method have been disclosed in Standard No. 51 “Paper and Paperboard-Liquid Absorption Test Method-Bristow Method”, JAPAN TAPPI PAPER AND PULP TEST METHODS, 2000. On the other hand, an absorbing recording medium indicates a recording medium corresponding to neither the non-absorbing recording medium nor the low-absorbing recording medium.

As the non-absorbing recording medium, for example, there may be mentioned a recording medium in which a recording surface includes a plastic or, more preferably, a recording medium in which a recoding surface is formed from a plastic. In the case described above, the recording surface has neither an absorbing layer to absorb a liquid nor a receiving layer. For example, there may be mentioned a recording medium in which a plastic is coated on a substrate, such as paper, a recording medium in which a plastic film is adhered to a substrate, such as paper, or a recording medium formed from a plastic film having neither a absorbing layer nor a receiving layer. As the plastic described above, for example, there may be mentioned a poly(vinyl chloride), a poly(ethylene terephthalate), a polycarbonate, a polystyrene, a polyurethane, a polyethylene, or a polypropylene.

In addition, as the low-absorbing recording medium, a recording medium called a coating paper having a surface on which a coating layer is provided may be mentioned. For example, as a low-absorbing recording medium using paper as the substrate, printing paper, such as art paper, coated paper, or mat paper, may be mentioned, and as a low-absorbing recording medium using a plastic film as the substrate, a recording medium in which, for example, a hydrophilic polymer is applied on a surface formed, for example, from a poly(vinyl chloride), a poly(ethylene terephthalate), a polycarbonate, a polystyrene, a polyurethane, a polyethylene, or a polypropylene or a recording medium in which particles formed of silica, titanium, or the like are applied together with a binder on the surface as described above may be mentioned.

In addition, the recording medium may be colorless transparent, translucent, colored transparent, colored opaque, colorless opaque, or the like.

### 2. Recording Method

A recording method according to one embodiment of the present disclosure is a recording method of performing recording on a recording medium which is a low-absorbing recording medium or a non-absorbing recording medium using the ink set described above and includes a black ink adhesion step of adhering the black ink composition to the recording medium by an ink jet method and a chromatic ink adhesion step of adhering the chromatic ink composition to the recording medium by an ink jet method.

According to the recording method of this embodiment, since the ink set described above is used, the wet spreadability of the black ink on the recording medium is made excellent, and the color development property (OD value) of the black image is also made excellent, and in addition, the color mixing between the black ink and the color ink can be reduced, and an excellent image quality (boundary bleeding) can be obtained.

In addition, as the recording medium which is a low-absorbing recording medium or a non-absorbing recording medium, a recording medium similar to that used for the ink set described above may be mentioned.

### 2.1. Black Ink Adhesion Step and Chromatic Ink Adhesion Step

The recording method according to this embodiment includes a black ink adhesion step of adhering the black ink composition included in the ink set described above to a recording medium by an ink jet method and a chromatic ink adhesion step of adhering the chromatic ink composition included in the ink set described above to the recording medium by an ink jet method.

In addition, the ink jet method is a recording method in which from ejection nozzles of an ink jet head included in a recording apparatus, such as an ink jet printer, fine liquid droplets of ink jet inks are ejected and adhered to a recording medium or the like.

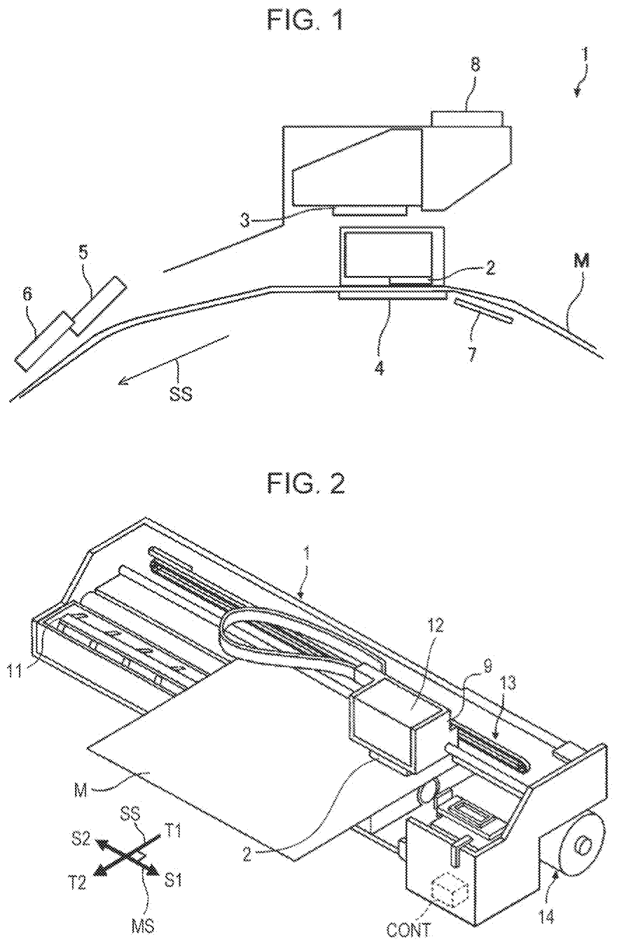

The black ink adhesion step and the chromatic ink adhesion step each can be easily performed such that for example, by using an ink jet recording apparatus 1 shown in FIG. 1 which is one embodiment of an ink jet recording apparatus to be described later, the ink is ejected from an ink jet head 2. In addition, a composition used for recording by ejection from an ink jet head by an ink jet method is called an ink jet ink.

The order of the black ink adhesion step and the chromatic ink adhesion step is not particularly limited, the chromatic ink adhesion step may be performed before the black ink adhesion step, the chromatic ink adhesion step may be performed after the black ink adhesion step, or the chromatic ink adhesion step may be simultaneously performed with the black ink adhesion step.

An adhesion amount of each of the black ink composition and the chromatic ink composition per unit area of a recording region of the recording medium is preferably 1 to 40 mg/inch², more preferably 2 to 30 mg/inch², even more preferably 4 to 20 mg/inch², and further preferably 6 to 16 mg/inch². The maximum ink adhesion amount per unite area of the recording region of the recording medium is preferably also set in the range described above. In addition, the ink adhesion amount of each ink composition can be independently adjusted.

In addition, in the black ink adhesion step and the chromatic ink adhesion step of the recording method according to this embodiment, a main scanning in which while the ink composition is ejected from an ink jet head, a relative position between the ink jet head and the recording medium is transferred is preferably performed a plurality of times, and the number of main scannings performed on the same main scanning region is preferably 10 times or less. An upper limit of the number of main scannings performed on the same main scanning region is more preferably 8 times or less, further preferably 6 times or less, and particularly preferably 4 times or less. Although a lower limit of the number of main scannings is one time or more and is not particularly limited, the lower limit described above is preferably 2 times or more and more preferably 3 times or more.

In addition, the “main scanning” indicates an operation in which while the relative position of the ink jet head to the recording medium is transferred, the ink composition is ejected from the ink jet head and adhered to the recording medium. The ink jet head may be mounted, for example, on a carriage. When the carriage is transferred, the ink jet head may be configured to be transferred, and also in this case, that is, the ink jet head is transferred. In addition, when the recording is performed on an arbitrary region, the number of passings of the ink jet head over the arbitrary region is called “pass number”. For example, when the main scanning to adhere the ink composition onto the same region is performed 4 times, for example, the pass number is called 4 passes.

In the main scanning, a time required for one main scanning is preferably 0.5 to 5 seconds, more preferably 1 to 4 seconds, and further preferably 2 to 3 seconds. The time for one main scanning (also called main scanning time in some cases) is a time required in one main scanning, to transfer a head location from a position facing one end of the recording medium to a position facing the other end thereof.

When the black ink composition and the chromatic ink composition are adhered to the recording medium, the black ink adhesion step and the chromatic ink adhesion step each may be performed on a recording medium having a surface temperature of 60° C. or less. That is, the black ink adhesion step and the chromatic ink adhesion step each may be performed with or without heating. Even when the heating is performed, the recording medium is preferably heated so as to have a surface temperature of 60° C. or less.

An upper limit of the surface temperature of the recording medium when the ink is adhered thereto is more preferably 50° C. or less, even more preferably 45° C. or less, further preferably 40° C. or less, even further preferably 35° C. or less, particularly preferably 28° C. or less. On the other hand, a lower of the surface temperature described above is preferably 20° C. or more, more preferably 23° C. or more, even more preferably 25° C. or more, further preferably 28° C. or more, even further preferably 35° C. or more, and particularly preferably 40° C. or more.

### 2.2. Primary Drying Step

The recording method according to this embodiment may further include a primary drying step of drying the black ink composition and the chromatic ink composition adhered to the recording medium. Since the step as described above is included, at an early stage in which the ink composition is adhered to the recording medium, the drying property of the ink can be improved, and the inter-color mixing tends to be further reduced.

The primary drying step is a step of drying the ink at an early stage in which the ink composition is adhered to the recording medium. The primary drying step is a drying step of drying at least part of a solvent component of the ink so as to at least decrease the fluidity of the ink. The drying of ink droplets landed on the recording medium by the primary drying step is preferably started within 0.5 seconds at the latest after the landing thereof.

As a method of the primary drying step, for example, there may be mentioned a method to perform ventilation at ordinary temperature (ordinary temperature wind) or ventilation with heating (hot wind) to a recording medium by a fan or the like; a radiation method using an IR heater or microwaves; a heat transfer method to heat a recording medium by a platen heater or the like; and a method to be performed in combination of the methods described above. In addition, in the primary drying step according to this embodiment, the method described above is not particularly limited as long as being capable of improving the drying property of the ink, and it should be noted that heating is not always required. Hence, in the primary drying step of this embodiment, the method to perform ventilation at ordinary temperature may be used alone. In addition, the primary drying step is more preferably performed by a method to be performed with heating.

When the drying is performed by ventilation in the primary drying step, a ventilation wind speed is preferably 0.5 to 15 m/s, more preferably 0.5 to 10 m/s, even more preferably 1 to 5 m/s, and further preferably 2 to 3 m/s. The wind speed is a wind speed in the vicinity of the surface of the recording medium. When the wind speed is in the range described above, for example, the inter-color mixing tends to be further reduced.

A wind temperature of the ventilation is preferably 50° C. or less and 10° C. or more, more preferably 15° C. to 45° C., even more preferably 20° C. to 49° C., further preferably 23° C. to 40° C., even further preferably 25° C. to 35° C., and particularly preferably 25° C. to 28° C. The wind temperature of the ventilation may also be ordinary temperature.

In addition, the surface temperature of the recording medium in the primary drying step may be preferably set in the temperature range described as the surface temperature of the recording medium in each of the black ink adhesion step and the chromatic ink adhesion step. That is, the surface temperature of the recording medium in the primary drying step is preferably 45° C. or less and is more preferably in the surface temperature range described above.

According to the recording method of this embodiment, since the drying can be performed even in the relatively low temperature range described above, the prevention of inter-color mixing between the inks, the wet spreadability, and the abrasion resistance can be made preferable with a good balance.

In addition, when the primary drying step is performed with heating, the primary drying step may be performed such that the ink is adhered to a heated recording medium or such that the heating is performed at an early stage after the ink adhesion. The primary drying step is preferably started within 0.5 seconds at the latest after ink droplets are landed on the recording medium.

When the primary drying step is performed with heating, the heating may be at least performed before the black ink adhesion step and the chromatic ink adhesion step, at the same time as that of the ink adhesion, and/or at an early stage after the ink adhesion and is preferably performed at the same time as that of the ink adhesion. By the heating order as described above, the black ink adhesion step and the chromatic ink adhesion step can be performed.

In addition, in the case in which the ink is adhered to the recording medium on which the primary drying step is performed, the surface temperature of the recording medium in the primary drying step is a surface temperature of the recording medium when the ink is adhered thereto, and in the case in which the primary drying step is performed at an early stage after the ink adhesion, the surface temperature described above is a surface temperature of the recording medium when the primary drying step is performed. In addition, the surface temperature described above is the maximum temperature in the primary drying step and by the primary drying step. The surface temperature of the recording medium in the primary drying step in the cases as described above is preferably set in the surface temperature range of the recording medium when the ink is adhered thereto.

In addition, in the case in which the primary drying step is performed without heating, the surface temperature of the recording medium is a surface temperature of the recording medium when the ink is adhered thereto.

### 2.3. Post-Heating Step

The recording method according to this embodiment may further include a post-heating step in which heating is performed on the recording medium to which the black ink composition and the chromatic ink composition are adhered so that the surface of the recording medium passing through a platen has a temperature of preferably 60° C. to 120° C., more preferably 70° C. to 110° C., and further preferably 80° C. to 100° C. Accordingly, the drying property is further improved, and a recorded matter having a more excellent abrasion resistance preferably tends to be obtained.

The post-heating step is a step to complete the recording and to sufficiently dry the recorded matter so as to be ready for use. The post-drying step is a drying step to sufficiently dry the solvent component of the ink and to form a film from a coating film of the ink by heating the fixing resin or the like to be contained therein.

After a certain point of the recording medium to which the ink is adhered in the above black ink adhesion step and chromatic ink adhesion step passes through the platen, the post-heating step is preferably started on the surface of the recording medium including the certain point described above. For example, in the ink jet recording apparatus 1 shown in FIGS. 1 and 2, after the ink is adhered to a certain point of a recording medium M by the ink jet head 2 facing a platen 11, and the certain point of the recording medium M to which the ink is adhered passes through the platen 11, the post-heating step is started by a heating heater 5 on the surface of the recording medium M including the certain point described above.

In addition, for example, when the ink jet recording apparatus is used, the heating of the recording medium in the post-heating step may be performed using an appropriate heating device. In addition, besides the heating device equipped in the ink jet recording apparatus, the heating may also be performed by an appropriate heating device.

In the post-heating step, a lower limit of the surface temperature of the recording medium is preferably 50° C. or more, more preferably 60° C. or more, even more preferably 70° C. or more, and further preferably 75° C. or more. An upper limit of the surface temperature of the recording medium is preferably 120° C. or less, more preferably 110° C. or less, even more preferably 100° C. or less, and further preferably 90° C. or less.

In addition, a preferable temperature in the primary drying step and a preferable temperature in the post-heating step are preferably different from each other.

### 2.4. Ink Jet Recording Apparatus

One example of an ink jet recording apparatus which can be used for the recording method according to this embodiment will be described with reference to the drawings.

FIG. 1 is a cross-sectional view schematically showing the ink jet recording apparatus 1. FIG. 2 is a perspective view showing one example of the structure of a carriage and its periphery of the ink jet recording apparatus 1 shown in FIG. 1. As shown in FIGS. 1 and 2, the ink jet recording apparatus 1 includes the ink jet head 2, an IR heater 3, a platen heater 4, the heating heater 5, a cooling fan 6, a pre-heater 7, a ventilation fan 8, a carriage 9, the platen 11, a carriage transfer mechanism 13, a transport device 14, and a control portion CONT. In the ink jet recording apparatus 1, all operations thereof are controlled by the control portion CONT shown in FIG. 2.

The ink jet head 2 has a structure to perform recording on the recording medium M by ejecting a black ink composition and a chromatic ink composition from nozzles of the ink jet head 2 so as to be adhered thereto. In this embodiment, the ink jet head 2 is a serial type ink jet head and is configured to adhere the ink to the recording medium M by a plurality of scannings performed in a main scanning direction relative to the recording medium M. The ink jet head 2 is mounted on the carriage 9 shown in FIG. 2. The ink jet head 2 is scanned a plurality of times in the main scanning direction relative to the recording medium M by the operation of the carriage transfer mechanism 13 to transfer the carriage 9 in a medium width direction of the recording medium M. The medium width direction is the main scanning direction of the ink jet head 2. The scanning in the main scanning direction is also called a main scanning.

In addition, the main scanning direction is a direction in which the carriage 9 mounting the ink jet head 2 is transferred. In FIG. 1, the main scanning direction is a direction intersecting a sub-scanning direction which is a transport direction of the recording medium M shown by an arrow SS. In FIG. 2, the width direction of the recording medium M, that is, a direction represented by S1-S2, is a main scanning direction MS, and a direction represented by T1→T2 is a sub-scanning direction SS. In addition, by one scanning, the scanning is performed in the main scanning direction, that is, in one direction represented by an arrow S1 or an arrow S2. In addition, since the main scanning of the ink jet head 2 and the sub-scanning which is the transport of the recording medium M are repeatedly performed at least two times, the ink is recorded on the recording medium M. That is, the black ink adhesion step and the chromatic ink adhesion step are performed by a plurality of main scannings in each of which the ink jet head 2 is transferred in the main scanning direction and by a plurality of sub-scannings in each of which the recording medium M is transported in the sub-scanning direction intersecting the main scanning direction.

The cartridge 12 to supply the ink compositions to the ink jet head 2 includes a plurality of independent cartridges. The cartridge 12 is detachably fitted to the carriage 9 mounting the ink jet head 2. In the respective cartridges, different types of ink compositions are filled, and the ink compositions are supplied to respective nozzles from the cartridge 12. In addition, in this embodiment, although the case in which the cartridge 12 is fitted to the carriage 9 is shown by way of example, the cartridge 12 is not limited thereto and may be provided at a position other than that of the carriage 9 so that the ink compositions are each supplied to the nozzle by a supply tube not shown.

For the ejection by the ink jet head 2, a known method may be used. In this embodiment, a method to eject a liquid droplet using vibration of a piezoelectric element, that is, an ejection method to form an ink droplet by a mechanical deformation of an electrostrictive element, is used.

The ink jet recording apparatus 1 includes the ventilation fan 8, the IR heater 3, and the platen heater 4 each of which is used to dry the ink composition ejected from the ink jet head 2 and adhered to the recording medium M. By appropriately using the ventilation fan 8, the IR heater 3, and the platen heater 4 in combination, the primary drying step can be performed. Furthermore, in the primary drying step, the recording medium M is not always required to be heated, and for example, the ventilation fan 8 may only be used to perform ventilation at ordinary temperature.

In addition, when the IR heater 3 is used, the recording medium M can be heated using a radiation method to radiate infrared rays from an ink jet head 2 side. Accordingly, although the ink jet head 2 is also liable to be simultaneously heated, compared to the case in which heating is performed from a rear surface of the recording medium M by the platen heater 4 or the like, the temperature can be increased without receiving the influence of the thickness of the recording medium M. In addition, there may be also provided various types of fans (such as the ventilation fan 8) to dry the ink on the recording medium M by supplying a hot wind or a wind having the same temperature as that in the environment to the recording medium M.

In order to perform the drying at an early stage after the ink composition ejected from the ink jet head 2 is adhered to the recording medium M, the platen heater 4 is configured to be able to heat the recording medium M at a position facing the ink jet head 2 with the platen 11 interposed therebetween. The platen heater 4 is able to heat the recording medium M by a conduction method, and in the recording method of this embodiment, the ink composition can be adhered to the recording medium M thus heated as described above. Hence, the ink composition can be fixed on the recording medium M at an early stage, and the image quality can be improved.

The heating heater 5 dries and solidifies the ink composition adhered to the recording medium M, that is, the heating heater 5 is a secondary heating heater or a secondary drying heater. The heating heater 5 can be used in the post-drying step. Since the heating heater 5 heats the recording medium M on which an image is recorded, for example, moisture contained in the ink composition is more rapidly evaporated and scattered, and an ink film is formed by the fixing resin to be contained in the ink composition. As described above, the ink film is tightly fixed or adhered onto the recording medium M so as to have an excellent film forming property, and hence, an image having an excellent high image quality can be obtained in a short time.

The ink jet recording apparatus 1 may also include the cooling fan 6. After the ink composition recorded on the recording medium M is dried, when the ink composition on the recording medium M is cooled by the cooling fan 6, an ink coating film can be formed so as to have an excellent adhesion onto the recording medium M.

In addition, the ink jet recording apparatus 1 may also include the pre-heater 7 to heat the recording medium M in advance before the ink composition is adhered to the recording medium M. Furthermore, the ink jet recording apparatus 1 may also include the ventilation fan 8 so as to more efficiently dry the ink composition adhered to the recording medium M.

At a lower side of the carriage 9, there are provided the platen 11 to support the recording medium M, the carriage transfer mechanism 13 to transfer the carriage 9 relative to the recording medium M, and the transport device 14 which is a roller to transport the recording medium M in the sub-scanning direction. The operations of the carriage transfer mechanism 13 and the transport device 14 are controlled by the control portion CONT.

In FIGS. 1 and 2, although the serial type ink jet recording apparatus is shown, a line type ink jet recording apparatus may also be used.

The ink jet recording apparatus described above by way of example can be preferably used to perform the recording method according to this embodiment.

### 3. EXAMPLES

Hereinafter, although the present disclosure will be described in more detail with reference to Examples, the present disclosure is not limited thereto. Hereinafter, “%” is on a mass basis unless otherwise particularly noted.

### 3.1. Preparation of Ink Composition

After components were charged in a container so as to have one of the compositions shown in the following Tables 1 to 3 and were then mixed and stirred for 2 hours by a magnetic stirrer, filtration was performed using a membrane filter having a pore size of 5 μm, so that black ink compositions and chromatic ink compositions according to Examples and Comparative Examples were obtained. The numerical values relating to the masses shown in the following Tables 1 to 3 each represent percent by mass, and the ion exchange water was added so that the total mass of the ink composition was 100 percent by mass. In addition, as the colorant, a pigment dispersion liquid was prepared such that a pigment and a dispersant which was a water-soluble styrene-acrylic resin at a mass ratio of pigment to dispersant of 2 to 1 were mixed and stirred with water in advance, and this pigment dispersion liquid was used for the preparation of the ink composition. In addition, the colorant, the fixing resin, and the wax in the tables each represent an effective component (on solid content basis).

TABLE 1

| | | STANDARD | | | | |
|---|---|---|---|---|---|---|
| | | BOILING | | | | |
| | | POINT | BLACK INK COMPOSITION | | | |
| COMPOSITION | | (° C.) | B01 | B02 | B03 | B04 |
| COLORANT | CARBON BLACK | — | 4 | 4 | 4 | 4 |
| FIXING RESIN | STYRENE-ACRYLIC RESIN | — | 3 | 3 | 3 | 3 |
| | (JONCRYL 537) | | | | | |
| WAX | POLYETHYLENE WAX | — | 1 | 1 | 1 | 1 |
| | (AQUACER539) | | | | | |
| ORGANIC SOLVENT | PROPYLENE GLYCOL | 188 | 15 | 15 | 15 | 15 |
| | 1,2-BUTANEDIOL | 193 | | | | |
| | 1,3-BUTANEDIOL | 207 | | | | |
| | 1,5-PENTANEDIOL | 239 | | | | |
| | GLYCERIN | 290 | | | | |
| | 2-PYRROLIDONE | 245 | | | | |
| | 1,2-HEXANEDIOL | 223 | 4 | 4 | 4 | 4 |
| SILICONE-BASED | BYK333 | — | | | 0.3 | |
| SURFACTANT 1 | | | | | | |
| SILICONE-BASED | BYK349 (SILICONE BASE) | — | 0.5 | 1 | 0.5 | 0.5 |
| SURFACTANT 2 | SURFACTANT FORMED IN | — | | | | |
| | PREPARATION EXAMPLE 1 | | | | | |
| OTHER SILICONE- | SAG503A (SILICONE BASE) | — | | | | |
| BASED SURFACTANT | | | | | | |
| GLYCOL | EHDG (2-ETHYLHEXYL | 272 | 1 | 1 | 1 | 0.5 |
| MONOETHER | DIGLYCOL) | | | | | |
| SOLVENT | HeDH (HEXYL DIGLYCOL) | 258 | | | | |
| | 3-METHOXY-1-BUTANOL | 158 | | | | |
| | BTG (BUTYL TRIGLYCOL) | 278 | | | | |
| OTHER SURFACTANT | PD002W (ACETYLENE BASE) | — | | | | |
| WATER | ION EXCHANGE WATER | — | BALANCE | BALANCE | BALANCE | BALANCE |
| TOTAL | | | 100 | 100 | 100 | 100 |
| TOTAL ORGANIC SOLVENT AMOUNT | | | 20.0 | 20.0 | 20.0 | 19.5 |
| RATIO OF SOLVENT HAVING b.p. OF LESS THAN 200° C. | | | 75 | 75 | 75 | 77 |
| (PERCENT BY MASS, TO TOTAL ORGANIC SOLVENT) | | | | | | |
| TOTAL SILICONE-BASED SURFACTANT AMOUNT | | | 0.5 | 1.0 | 0.8 | 0.5 |
| | | STANDARD | | | | |
| | | BOILING | | | | |
| | | POINT | BLACK INK COMPOSITION | | | |
| COMPOSITION | | (° C.) | B05 | B06 | B07 | B08 |
| COLORANT | CARBON BLACK | — | 4 | 4 | 4 | 4 |
| FIXING RESIN | STYRENE-ACRYLIC RESIN | — | 3 | 3 | 3 | 3 |
| | (JONCRYL 537) | | | | | |
| WAX | POLYETHYLENE WAX | — | 1 | 1 | 1 | 1 |
| | (AQUACER539) | | | | | |
| ORGANIC SOLVENT | PROPYLENE GLYCOL | 188 | 15 | 15 | 15 | 15 |
| | 1,2-BUTANEDIOL | 193 | | | | |
| | 1,3-BUTANEDIOL | 207 | | | | |
| | 1,5-PENTANEDIOL | 239 | | | | |
| | GLYCERIN | 290 | | | | |
| | 2-PYRROLIDONE | 245 | | | | |
| | 1,2-HEXANEDIOL | 223 | 4 | 4 | 4 | 4 |
| SILICONE-BASED | BYK333 | — | | | | |
| SURFACTANT 1 | | | | | | |
| SILICONE-BASED | BYK349 (SILICONE BASE) | — | 0.5 | | | 0.5 |
| SURFACTANT 2 | SURFACTANT FORMED IN | — | | | | |
| | PREPARATION EXAMPLE 1 | | | | | |
| OTHER SILICONE- | SAG503A (SILICONE BASE) | — | | 0.5 | | |
| BASED SURFACTANT | | | | | | |
| GLYCOL | EHDG (2-ETHYLHEXYL | 272 | 2 | 1 | 1 | |
| MONOETHER | DIGLYCOL) | | | | | |
| SOLVENT | HeDH (HEXYL DIGLYCOL) | 258 | | | | 1 |
| | 3-METHOXY-1-BUTANOL | 158 | | | | |
| | BTG (BUTYL TRIGLYCOL) | 278 | | | | |
| OTHER SURFACTANT | PD002W (ACETYLENE BASE) | — | | | 0.5 | |
| WATER | ION EXCHANGE WATER | — | BALANCE | BALANCE | BALANCE | BALANCE |
| TOTAL | | | 100 | 100 | 100 | 100 |
| TOTAL ORGANIC SOLVENT AMOUNT | | | 21.0 | 20.0 | 20.0 | 20.0 |
| RATIO OF SOLVENT HAVING b.p. OF LESS THAN 200° C. | | | 71 | 75 | 75 | 75 |
| (PERCENT BY MASS, TO TOTAL ORGANIC SOLVENT) | | | | | | |
| TOTAL SILICONE-BASED SURFACTANT AMOUNT | | | 0.5 | 0.5 | — | 0.5 |
| | | STANDARD | | | | |
| | | BOILING | | | | |
| | | POINT | BLACK INK COMPOSITION | | | |
| COMPOSITION | | (° C.) | B09 | B10 | B11 | B12 |
| COLORANT | CARBON BLACK | — | 4 | 4 | 4 | 4 |
| FIXING RESIN | STYRENE-ACRYLIC RESIN | — | 3 | 3 | 3 | 3 |
| | (JONCRYL 537) | | | | | |
| WAX | POLYETHYLENE WAX | — | 1 | 1 | 1 | 1 |
| | (AQUACER539) | | | | | |
| ORGANIC SOLVENT | PROPYLENE GLYCOL | 188 | 15 | | | |
| | 1,2-BUTANEDIOL | 193 | | 15 | | |
| | 1,3-BUTANEDIOL | 207 | | | 15 | |
| | 1,5-PENTANEDIOL | 239 | | | | 15 |
| | GLYCERIN | 290 | | | | |
| | 2-PYRROLIDONE | 245 | | | | |
| | 1,2-HEXANEDIOL | 223 | 4 | 4 | 4 | 4 |
| SILICONE-BASED | BYK333 | — | | | | |
| SURFACTANT 1 | | | | | | |
| SILICONE-BASED | BYK349 (SILICONE BASE) | — | 0.5 | 0.5 | 0.5 | 0.5 |
| SURFACTANT 2 | SURFACTANT FORMED IN | — | | | | |
| | PREPARATION EXAMPLE 1 | | | | | |
| OTHER SILICONE- | SAG503A (SILICONE BASE) | — | | | | |
| BASED SURFACTANT | | | | | | |
| GLYCOL | EHDG (2-ETHYLHEXYL | 272 | | 1 | 1 | 1 |
| MONOETHER | DIGLYCOL) | | | | | |
| SOLVENT | HeDH (HEXYL DIGLYCOL) | 258 | | | | |
| | 3-METHOXY-1-BUTANOL | 158 | | | | |
| | BTG (BUTYL TRIGLYCOL) | 278 | 1 | | | |
| OTHER SURFACTANT | PD002W (ACETYLENE BASE) | — | | | | |
| WATER | ION EXCHANGE WATER | — | BALANCE | BALANCE | BALANCE | BALANCE |

| | | | | |
|---|---|---|---|---|
| TOTAL | 100 | 100 | 100 | 100 |
| TOTAL ORGANIC SOLVENT AMOUNT | 20.0 | 20.0 | 20.0 | 20.0 |
| RATIO OF SOLVENT HAVING b.p. OF LESS THAN 200° C. | 75 | 75 | 0 | 0 |
| (PERCENT BY MASS, TO TOTAL ORGANIC SOLVENT) | | | | |
| TOTAL SILICONE-BASED SURFACTANT AMOUNT | 0.5 | 0.5 | 0.5 | 0.5 |

TABLE 2

| | | STANDARD | | | | |
|---|---|---|---|---|---|---|
| | | BOILING | | | | |
| | | POINT | BLACK INK COMPOSITION | | | |
| COMPOSITION | | (° C.) | B13 | B14 | B15 | B16 |
| COLORANT | CARBON BLACK | — | 4 | 4 | 4 | 4 |
| FIXING RESIN | STYRENE-ACRYLIC RESIN | — | 3 | 3 | 3 | 3 |
| | (JONCRYL 537) | | | | | |
| WAX | POLYETHYLENE WAX | — | 1 | 1 | 1 | 1 |
| | (AQUACER539) | | | | | |
| ORGANIC SOLVENT | PROPYLENE GLYCOL | 188 | 9 | 13 | 10 | 15 |
| | 1,2-BUTANEDIOL | 193 | | | | |
| | 1,3-BUTANEDIOL | 207 | 6 | | | |
| | 1,5-PENTANEDIOL | 239 | | | | |
| | GLYCERIN | 290 | | 2 | | |
| | 2-PYRROLIDONE | 245 | | | 5 | |
| | 1,2-HEXANEDIOL | 223 | 4 | 4 | 4 | 4 |
| SILICONE-BASED | BYK333 | — | | | | |
| SURFACTANT 1 | | | | | | |
| SILICONE-BASED | BYK349 (SILICONE BASE) | — | 0.5 | 0.5 | 0.5 | |
| SURFACTANT 2 | SURFACTANT FORMED IN | — | | | | |
| | PREPARATION EXAMPLE 1 | | | | | |
| OTHER SILICONE- | SAG503A (SILICONE BASE) | — | | | | 0.8 |
| BASED SURFACTANT | | | | | | |
| GLYCOL | EHDG (2-ETHYLHEXYL | 272 | 1 | 1 | 1 | |
| MONOETHER | DIGLYCOL) | | | | | |
| SOLVENT | HeDH (HEXYL DIGLYCOL) | 258 | | | | |
| | 3-METHOXY-1-BUTANOL | 158 | | | | |
| | BTG (BUTYL TRIGLYCOL) | 278 | | | | |
| OTHER SURFACTANT | PD002W (ACETYLENE BASE) | — | | | | |
| WATER | ION EXCHANGE WATER | — | BALANCE | BALANCE | BALANCE | BALANCE |
| TOTAL | | | 100 | 100 | 100 | 100 |
| TOTAL ORGANIC SOLVENT AMOUNT | | | 20.0 | 20.0 | 20.0 | 19.0 |
| RATIO OF SOLVENT HAVING b.p. OF LESS THAN 200° C. | | | 45 | 65 | 50 | 79 |
| (PERCENT BY MASS, TO TOTAL ORGANIC SOLVENT) | | | | | | |
| TOTAL SILICONE-BASED SURFACTANT AMOUNT | | | 0.5 | 0.5 | 0.5 | 0.8 |
| | | STANDARD | | | | |
| | | BOILING | | | | |
| | | POINT | BLACK INK COMPOSITION | | | |
| COMPOSITION | | (° C.) | B17 | B18 | B19 | B20 |
| COLORANT | CARBON BLACK | — | 4 | 4 | 4 | 4 |
| FIXING RESIN | STYRENE-ACRYLIC RESIN | — | 3 | 3 | 3 | 3 |
| | (JONCRYL 537) | | | | | |
| WAX | POLYETHYLENE WAX | — | 1 | 1 | 1 | 1 |
| | (AQUACER539) | | | | | |
| ORGANIC SOLVENT | PROPYLENE GLYCOL | 188 | 15 | 15 | 15 | 15 |
| | 1,2-BUTANEDIOL | 193 | | | | |
| | 1,3-BUTANEDIOL | 207 | | | | |
| | 1,5-PENTANEDIOL | 239 | | | | |
| | GLYCERIN | 290 | | | | |
| | 2-PYRROLIDONE | 245 | | | | |
| | 1,2-HEXANEDIOL | 223 | 4 | 4 | 4 | 4 |
| SILICONE-BASED | BYK333 | — | | 0.8 | | |
| SURFACTANT 1 | | | | | | |
| SILICONE-BASED | BYK349 (SILICONE BASE) | — | | | 0.5 | |
| SURFACTANT 2 | SURFACTANT FORMED IN | — | | | | 0.5 |
| | PREPARATION EXAMPLE 1 | | | | | |
| OTHER SILICONE- | SAG503A (SILICONE BASE) | — | | | | |
| BASED SURFACTANT | | | | | | |
| GLYCOL | EHDG (2-ETHYLHEXYL | 272 | | | | 1 |
| MONOETHER | DIGLYCOL) | | | | | |
| SOLVENT | HeDH (HEXYL DIGLYCOL) | 258 | | | | |
| | 3-METHOXY-1-BUTANOL | 158 | | | | |
| | BTG (BUTYL TRIGLYCOL) | 278 | | | | |
| OTHER SURFACTANT | PD002W (ACETYLENE BASE) | — | 1 | | | |
| WATER | ION EXCHANGE WATER | — | BALANCE | BALANCE | BALANCE | BALANCE |

| | | | | |
|---|---|---|---|---|
| TOTAL | 100 | 100 | 100 | 100 |
| TOTAL ORGANIC SOLVENT AMOUNT | 19.0 | 19.0 | 19.0 | 20.0 |
| RATIO OF SOLVENT HAVING b.p. OF LESS THAN 200° C. | 79 | 79 | 79 | 75 |
| (PERCENT BY MASS, TO TOTAL ORGANIC SOLVENT) | | | | |
| TOTAL SILICONE-BASED SURFACTANT AMOUNT | — | 0.8 | 0.5 | 0.5 |

| | | STANDARD | | | |
|---|---|---|---|---|---|
| | | BOILING | | | |
| | | POINT | BLACK INK COMPOSITION | | |
| COMPOSITION | | (° C.) | B21 | B22 | B23 |
| COLORANT | CARBON BLACK | — | 4 | 4 | 4 |
| FIXING RESIN | STYRENE-ACRYLIC RESIN | — | 3 | 3 | 3 |
| | (JONCRYL 537) | | | | |
| WAX | POLYETHYLENE WAX | — | 1 | 1 | 1 |
| | (AQUACER539) | | | | |
| ORGANIC SOLVENT | PROPYLENE GLYCOL | 188 | 15 | 23 | 15 |
| | 1,2-BUTANEDIOL | 193 | | | |
| | 1,3-BUTANEDIOL | 207 | | | |
| | 1,5-PENTANEDIOL | 239 | | | |
| | GLYCERIN | 290 | | | |
| | 2-PYRROLIDONE | 245 | | | |
| | 1,2-HEXANEDIOL | 223 | 4 | 7 | 4 |
| SILICONE-BASED | BYK333 | — | | | |
| SURFACTANT 1 | | | | | |
| SILICONE-BASED | BYK349 (SILICONE BASE) | — | 0.3 | 0.5 | 0.5 |
| SURFACTANT 2 | SURFACTANT FORMED IN | — | | | |
| | PREPARATION EXAMPLE 1 | | | | |
| OTHER SILICONE- | SAG503A (SILICONE BASE) | — | | | |
| BASED SURFACTANT | | | | | |
| GLYCOL | EHDG (2-ETHYLHEXYL | 272 | 1 | 1 | |
| MONOETHER | DIGLYCOL) | | | | |
| SOLVENT | HeDH (HEXYL DIGLYCOL) | 258 | | | |
| | 3-METHOXY-1-BUTANOL | 158 | | | 1 |
| | BTG (BUTYL TRIGLYCOL) | 278 | | | |
| OTHER SURFACTANT | PD002W (ACETYLENE BASE) | — | | | |
| WATER | ION EXCHANGE WATER | — | BALANCE | BALANCE | BALANCE |

| | | | |
|---|---|---|---|
| TOTAL | 100 | 100 | 100 |
| TOTAL ORGANIC SOLVENT AMOUNT | 20.0 | 31.0 | 20.0 |
| RATIO OF SOLVENT HAVING b.p. OF LESS THAN 200° C. | 75 | 74 | 80 |
| (PERCENT BY MASS, TO TOTAL ORGANIC SOLVENT) | | | |
| TOTAL SILICONE-BASED SURFACTANT AMOUNT | 0.3 | 0.5 | 0.5 |

TABLE 3

| | | STANDARD | | | | | |
|---|---|---|---|---|---|---|---|
| | | BOILING | | | | | |
| | | POINT | CHROMATIC INK COMPOSITION | | | | |
| COMPOSITION | | (° C.) | C01 | C02 | C03 | C04 | C05 |
| COLORANT | P.B.15:3 | — | 4 | 4 | 4 | 4 | 4 |
| FIXING RESIN | STYRENE-ACRYLIC | — | 3 | 3 | 3 | 3 | 3 |
| | RESIN (JONCRYL 537) | | | | | | |
| WAX | POLYETHYLENE WAX | — | 1 | 1 | 1 | 1 | 1 |
| | (AQUACER539) | | | | | | |
| ORGANIC SOLVENT | PROPYLENE GLYCOL | 188 | 15 | 15 | 15 | 15 | 15 |
| | 1,2-HEXANEDIOL | 223 | 4 | 4 | 4 | 4 | 4 |
| SILICONE-BASED | BYK333 | — | 0.3 | | 0.3 | 0.5 | |
| SURFACTANT 1 | BYK3480 | — | | | | | |
| SILICONE-BASED | BYK349 (SILICONE BASE) | — | 0.7 | 0.5 | | 1 | |
| SURFACTANT 2 | | | | | | | |
| OTHER SILICONE- | SAG503A (SILICONE BASE) | — | | | 0.7 | | |
| BASED SURFACTANT | | | | | | | |
| GLYCOL | EHDG (2-ETHYLHEXYL | 272 | | | | | |
| MONOETHER | DIGLYCOL) | | | | | | |
| SOLVENT | HeDH (HEXYL DIGLYCOL) | 258 | | | | | |
| | 3-METHOXY-1-BUTANOL | 158 | | | | | |
| | BTG (BUTYL TRIGLYCOL) | 278 | | | | | |
| OTHER SURFACTANT | PD002W (ACETYLENE BASE) | — | | | | | 1 |
| WATER | ION EXCHANGE WATER | — | BALANCE | BALANCE | BALANCE | BALANCE | BALANCE |
| TOTAL | | | 100 | 100 | 100 | 100 | 100 |
| TOTAL ORGANIC SOLVENT AMOUNT | | | 19.0 | 19.0 | 19.0 | 19.0 | 19.0 |
| RATIO OF SOLVENT HAVING b.p. OF LESS THAN 200° C. | | | 79 | 79 | 79 | 79 | 79 |
| (PERCENT BY MASS, TO TOTAL ORGANIC SOLVENT) | | | | | | | |
| TOTAL SILICONE-BASED SURFACTANT AMOUNT | | | 1.0 | 0.5 | 1.0 | 1.5 | — |
| | | STANDARD | | | | | |
| | | BOILING | | | | | |
| | | POINT | CHROMATIC INK COMPOSITION | | | | |
| COMPOSITION | | (° C.) | C06 | C07 | C08 | C09 | C10 |
| COLORANT | P.B.15:3 | — | 4 | 4 | 4 | 4 | 4 |
| FIXING RESIN | STYRENE-ACRYLIC | — | 3 | 3 | 3 | 3 | 3 |
| | RESIN (JONCRYL 537) | | | | | | |
| WAX | POLYETHYLENE WAX | — | 1 | 1 | 1 | 1 | 1 |
| | (AQUACER539) | | | | | | |
| ORGANIC SOLVENT | PROPYLENE GLYCOL | 188 | 15 | 15 | 15 | 15 | 15 |
| | 1,2-HEXANEDIOL | 223 | 4 | 4 | 4 | 4 | 4 |
| SILICONE-BASED | BYK333 | — | 0.3 | 0.3 | 0.3 | | |
| SURFACTANT 1 | BYK3480 | — | | | | | |
| SILICONE-BASED | BYK349 (SILICONE BASE) | — | 0.7 | 0.7 | 0.7 | 1 | |
| SURFACTANT 2 | | | | | | | |
| OTHER SILICONE- | SAG503A (SILICONE BASE) | — | | | | | 1 |
| BASED SURFACTANT | | | | | | | |
| GLYCOL | EHDG (2-ETHYLHEXYL | 272 | 1 | | | | |
| MONOETHER | DIGLYCOL) | | | | | | |
| SOLVENT | HeDH (HEXYL DIGLYCOL) | 258 | | 1 | | | |
| | 3-METHOXY-1-BUTANOL | 158 | | | | | |
| | BTG (BUTYL TRIGLYCOL) | 278 | | | 1 | | |
| OTHER SURFACTANT | PD002W (ACETYLENE BASE) | — | | | | | |
| WATER | ION EXCHANGE WATER | — | BALANCE | BALANCE | BALANCE | BALANCE | BALANCE |

| | | | | | |
|---|---|---|---|---|---|
| TOTAL | 100 | 100 | 100 | 100 | 100 |
| TOTAL ORGANIC SOLVENT AMOUNT | 20.0 | 20.0 | 20.0 | 19.0 | 19.0 |
| RATIO OF SOLVENT HAVING b.p. OF LESS THAN 200° C. | 75 | 75 | 75 | 79 | 79 |
| (PERCENT BY MASS, TO TOTAL ORGANIC SOLVENT) | | | | | |
| TOTAL SILICONE-BASED SURFACTANT AMOUNT | 1.0 | 1.0 | 1.0 | 1.0 | 1.0 |

| | | STANDARD | | | | |
|---|---|---|---|---|---|---|
| | | BOILING | | | | |
| | | POINT | CHROMATIC INK COMPOSITION | | | |
| COMPOSITION | | (° C.) | C11 | C12 | C13 | C14 |
| COLORANT | P.B.15:3 | — | 4 | 4 | 4 | 4 |
| FIXING RESIN | STYRENE-ACRYLIC | — | 3 | 3 | 3 | 3 |
| | RESIN (JONCRYL 537) | | | | | |
| WAX | POLYETHYLENE WAX | — | 1 | 1 | 1 | 1 |
| | (AQUACER539) | | | | | |
| ORGANIC SOLVENT | PROPYLENE GLYCOL | 188 | 15 | 15 | 15 | 15 |
| | 1,2-HEXANEDIOL | 223 | 4 | 4 | 4 | 4 |
| SILICONE-BASED | BYK333 | — | | 0.2 | 0.7 | 0.3 |
| SURFACTANT 1 | BYK3480 | — | 0.3 | | | |
| SILICONE-BASED | BYK349 (SILICONE BASE) | — | 0.7 | 0.8 | 0.3 | |
| SURFACTANT 2 | | | | | | |
| OTHER SILICONE- | SAG503A (SILICONE BASE) | — | | | | 0.7 |
| BASED SURFACTANT | | | | | | |
| GLYCOL | EHDG (2-ETHYLHEXYL | 272 | | | | 1 |
| MONOETHER | DIGLYCOL) | | | | | |
| SOLVENT | HeDH (HEXYL DIGLYCOL) | 258 | | | | |
| | 3-METHOXY-1-BUTANOL | 158 | | | | |
| | BTG (BUTYL TRIGLYCOL) | 278 | | | | |
| OTHER SURFACTANT | PD002W (ACETYLENE BASE) | — | | | | |
| WATER | ION EXCHANGE WATER | — | BALANCE | BALANCE | BALANCE | BALANCE |

| | | | | |
|---|---|---|---|---|
| TOTAL | 100 | 100 | 100 | 100 |
| TOTAL ORGANIC SOLVENT AMOUNT | 19.0 | 19.0 | 19.0 | 20.0 |
| RATIO OF SOLVENT HAVING b.p. OF LESS THAN 200° C. | 79 | 79 | 79 | 75 |
| (PERCENT BY MASS, TO TOTAL ORGANIC SOLVENT) | | | | |
| TOTAL SILICONE-BASED SURFACTANT AMOUNT | 1.0 | 1.0 | 1.0 | 1.0 |

The above Tables 1 to 3 will be further additionally described.

### Technical Terms

“SILICONE-BASED SURFACTANT 1”: silicone-based surfactant 1 in which, in a molecular weight distribution by a gel permeation chromatography, the maximum peak in a molecular weight range of 300 or more is located in a range of 3,000 to 20,000.

“SILICONE-BASED SURFACTANT 2”: silicone-based surfactant 2 in which, in a molecular weight distribution by a gel permeation chromatography, the maximum peak in a molecular weight range of 300 or more is located in a range of 300 to 1,500.

“RATIO OF SOLVENT HAVING b.p. OF LESS THAN 200° C.”: ratio of a content (percent by mass) of an organic solvent having a standard boiling point of less than 200° C. to a total organic solvent amount (percent by mass).

“TOTAL SILICONE-BASED SURFACTANT AMOUNT”: total amount of the silicone-based surfactant 1, the silicone-based surfactant 2, and the other silicone-based surfactant.

### Components

—Colorant—
“P.B.15: 3”: C.I. Pigment Blue 15: 3

—Fixing Resin—
“JONCRYL 537”: styrene-acrylic-based resin, manufactured by BASF

—Wax—
“AQUACER 539”: polyethylene-based wax, manufactured by BYK Japan KK

—Silicone-Based Surfactant 1—
“BYK 333”: manufactured by BYK Japan KK, the maximum peak in a molecular weight range of 300 or more is located at a molecular weight of 6,760 in a molecular weight distribution by a GPC measurement.
“BYK 3480”: manufactured by BYK Japan KK, the maximum peak in a molecular weight range of 300 or more is located at a molecular weight of 4,330 in a molecular weight distribution by a GPC measurement.

—Silicone-Based Surfactant 2—
“BYK 349”: manufactured by BYK Japan KK, the maximum peak in a molecular weight range of 300 or more is located at a molecular weight of 1,470 in a molecular weight distribution by a GPC measurement.
“Surfactant Formed in Preparation Example 1”: The maximum peak in a molecular weight range of 300 or more is located at a molecular weight of 950 in a molecular weight distribution by a GPC measurement.

—Other Silicone-Based Surfactant—
“SAG503A”: manufactured by Nisshin Chemical Industry Co., Ltd.

—Glycol Monoether Solvent—
“EHDG (2-ETHYLHEXYL GLYCOL)”: alias: diethylene glycol mono(2-ethylhexyl) ether
“HeDH (HEXYL DIGLYCOL)”: alias: diethylene glycol monohexyl ether
“BTG (BUTYL TRIGLYCOL)”: alias: triethylene glycol monobutyl ether

—Other Surfactant—
“PD002W”: Olfine PD002W, manufactured by Nisshin Chemical Industry Co., Ltd.

### 3.2. Preparation Example 1 (Silicone-Based Surfactant 2)

A predetermined organohydrogen polysiloxane and a polyether corresponding thereto having a carbon-carbon double bond at a molecular terminal were allowed to react with each other under the presence of a platinum catalyst. By a structural analysis of the reactant thus obtained using a liquid chromatography mass analysis (LC-MS), it was found that a silicone-based surfactant 2 of the preparation example 1 in which in the above general formulas (3) and (4), d=3 to 5, e=1 to 4, f=1 to 4, g=0, R³=CH₃, R⁴=—CH₂—, and R⁵=H were satisfied was obtained.

### 3.3. Measurement of Molecular Weight Distribution

The molecular weight distributions of the silicone-based surfactant 1 and the silicone-based surfactant 2 shown in the above Tables 1 to 3 were measured by a gel permeation chromatography, so that the maximum peaks in a molecular weight range of 300 or more were obtained. The measurement conditions are as shown below.

Measurement Conditions
Solvent: tetrahydrofuran
Columns: TSKgel Super HZM-NX2+TSKgel guardcolumn SuperHZ-L
column temperature: 40° C.
charge amount: 25 μL
detector: differential refractometer (RI)
flow rate: 0.35 mL/min
calibration curve: a calibration curve obtained from 13 samples having MW's of 1,000,000 to 500 using standard polystyrenes, STK standard polystyrenes (manufactured by Tosoh Corporation), was used.

### 3.4. Recording Method

A printer (SC-580650 modified machine, manufactured by Seiko Epson Corporation) was prepared, and the ink compositions were each filled in one nozzle line of an ink jet head. In the ink jet head of the printer, a nozzle density of the nozzle line was 360 dpi, 360 nozzles were provided. In addition, the printer has a platen heater to perform a primary drying step at a position facing the ink jet head, and a surface temperature of a recording medium was controlled at one of the values shown in Tables 4 to 6. Furthermore, a secondary heater was provided downstream of the printer, and in second drying, the recording medium was controlled so as to have a surface temperature of 70° C. In the case described above, as a primary drying mechanism in this Example, a platen heater and a ventilation fan were provided, and a wind speed by the fan was set to one of the values shown in the tables. As the wind speed, a wind speed in the vicinity of the surface of the recording medium right below the ink jet head was used. A wind temperature was measured in advance in the vicinity of the surface of the recording medium so as not to receive the influence of the platen heater.

By using the printer thus formed, recording of a solid pattern was performed on “M1”: PET50A (transparent PET film, manufactured by Lintec Corporation) or “M2”: regular paper (P paper, manufactured by Xerox) at a recording resolution of 720 dpi×720 dpi by 4 passes under the conditions shown in the following Tables 4 to 6. In this recording, by adjusting the number of ink droplets per one pass, the ink adhesion amounts were each set to 7 mg/inch².

In addition, in the following Tables 4 to 6, “SILICONE-BASED SURFACTANT AMOUNT Bk<COLOR” indicates whether or not a total amount of the silicone-based surfactant of the black ink composition used in one Example is smaller than a total amount of the silicone-based surfactant of the chromatic ink composition used in the same Example, when the former total amount is smaller, “Y” is shown in the column, and when the former total amount is not smaller, “N” is shown in the column. In addition, “MEDIUM SURFACE TEMPERATURE” in the table represents a temperature in the primary drying step.

TABLE 4

| | | EXAMPLE 1 | EXAMPLE 2 | EXAMPLE 3 | EXAMPLE 4 | EXAMPLE 5 |
|---|---|---|---|---|---|---|
| BLACK INK COMPOSITION | | B01 | B02 | B03 | B04 | B05 |
| CHROMATIC INK COMPOSITION | | C01 | C01 | C01 | C01 | C01 |
| SILICONE-BASED SURFACTANT AMOUNT | | Y | Y | Y | Y | Y |
| Bk < COLOR | | | | | | |
| TYPE OF RECORDING MEDIUM | | M1 | M1 | M1 | M1 | M1 |
| MEDIUM SURFACE TEMPERATURE (° C.) | | 45 | 45 | 45 | 45 | 45 |
| VENTILATION (WIND SPEED m/s) | | 2 | 2 | 2 | 2 | 2 |
| WIND TEMPERATURE (° C.) | | 25 | 25 | 25 | 25 | 25 |
| IMAGE QUALITY (BOUNDARY BLEEDING) | | B | C | A | B | B |
| Bk | IMAGE QUALITY | A | A | A | B | A |
| IMAGE | (OD VALUE) | | | | | |
| QUALITY | IMAGE QUALITY | B | B | A | C | B |
| | (IRREGULARITY) | | | | | |
| | ABRASION | B | D | C | A | D |
| | RESISTANCE | | | | | |
| COLOR | IMAGE QUALITY | B | B | B | B | B |
| IMAGE | (OD VALUE) | | | | | |
| QUALITY | IMAGE QUALITY | B | B | B | B | B |
| | (IRREGULARITY) | | | | | |
| | ABRASION | A | A | A | A | A |
| | RESISTANCE | | | | | |
| | | EXAMPLE 6 | EXAMPLE 7 | EXAMPLE 8 | EXAMPLE 9 | EXAMPLE 10 |
| BLACK INK COMPOSITION | | B06 | B07 | B08 | B09 | B10 |
| CHROMATIC INK COMPOSITION | | C01 | C01 | C01 | C01 | C01 |
| SILICONE-BASED SURFACTANT AMOUNT | | Y | Y | Y | Y | Y |
| Bk < COLOR | | | | | | |
| TYPE OF RECORDING MEDIUM | | M1 | M1 | M1 | M1 | M1 |
| MEDIUM SURFACE TEMPERATURE (° C.) | | 45 | 45 | 45 | 45 | 45 |
| VENTILATION (WIND SPEED m/s) | | 2 | 2 | 2 | 2 | 2 |
| WIND TEMPERATURE (° C.) | | 25 | 25 | 25 | 25 | 25 |
| IMAGE QUALITY (BOUNDARY BLEEDING) | | B | B | B | B | B |
| Bk | IMAGE QUALITY | B | C | B | C | A |
| IMAGE | (OD VALUE) | | | | | |
| QUALITY | IMAGE QUALITY | C | D | C | C | B |
| | (IRREGULARITY) | | | | | |
| | ABRASION | B | B | B | B | B |
| | RESISTANCE | | | | | |
| COLOR | IMAGE QUALITY | B | B | B | B | B |
| IMAGE | (OD VALUE) | | | | | |
| QUALITY | IMAGE QUALITY | B | B | B | B | B |
| | (IRREGULARITY) | | | | | |
| | ABRASION | A | A | A | A | A |
| | RESISTANCE | | | | | |
| | | EXAMPLE 11 | EXAMPLE 12 | EXAMPLE 13 | EXAMPLE 14 | EXAMPLE 15 |
| BLACK INK COMPOSITION | | B11 | B12 | B13 | B14 | B15 |
| CHROMATIC INK COMPOSITION | | C01 | C01 | C01 | C01 | C01 |
| SILICONE-BASED SURFACTANT AMOUNT | | Y | Y | Y | Y | Y |
| Bk < COLOR | | | | | | |
| TYPE OF RECORDING MEDIUM | | M1 | M1 | M1 | M1 | M1 |
| MEDIUM SURFACE TEMPERATURE (° C.) | | 45 | 45 | 45 | 45 | 45 |
| VENTILATION (WIND SPEED m/s) | | 2 | 2 | 2 | 2 | 2 |
| WIND TEMPERATURE (° C.) | | 25 | 25 | 25 | 25 | 25 |
| IMAGE QUALITY (BOUNDARY BLEEDING) | | B | B | B | B | B |
| Bk | IMAGE QUALITY | A | A | A | A | A |
| IMAGE | (OD VALUE) | | | | | |
| QUALITY | IMAGE QUALITY | B | B | B | B | B |
| | (IRREGULARITY) | | | | | |
| | ABRASION | C | C | C | D | C |
| | RESISTANCE | | | | | |
| COLOR | IMAGE QUALITY | B | B | B | B | B |
| IMAGE | (OD VALUE) | | | | | |
| QUALITY | IMAGE QUALITY | B | B | B | B | B |
| | (IRREGULARITY) | | | | | |
| | ABRASION | A | A | A | A | A |
| | RESISTANCE | | | | | |

TABLE 5

| | | EXAMPLE 16 | EXAMPLE 17 | EXAMPLE 18 | EXAMPLE 19 | EXAMPLE 20 |
|---|---|---|---|---|---|---|
| BLACK INK COMPOSITION | | B19 | B20 | B21 | B22 | B23 |
| CHROMATIC INK COMPOSITION | | C01 | C01 | C01 | C01 | C01 |
| SILICONE-BASED SURFACTANT AMOUNT | | Y | Y | Y | Y | Y |
| Bk < COLOR | | | | | | |
| TYPE OF RECORDING MEDIUM | | M1 | M1 | M1 | M1 | M1 |
| MEDIUM SURFACE TEMPERATURE (° C.) | | 45 | 45 | 45 | 45 | 45 |
| VENTILATION (WIND SPEED m/s) | | 2 | 2 | 2 | 2 | 2 |
| WIND TEMPERATURE (° C.) | | 25 | 25 | 25 | 25 | 25 |
| IMAGE QUALITY (BOUNDARY BLEEDING) | | A | B | B | C | B |
| Bk | IMAGE QUALITY | C | A | B | A | A |
| IMAGE | (OD VALUE) | | | | | |
| QUALITY | IMAGE QUALITY | C | A | C | C | A |
| | (IRREGULARITY) | | | | | |
| | ABRASION | A | A | A | C | A |
| | RESISTANCE | | | | | |
| COLOR | IMAGE QUALITY | B | B | B | B | B |
| IMAGE | (OD VALUE) | | | | | |
| QUALITY | IMAGE QUALITY | B | B | B | B | B |
| | (IRREGULARITY) | | | | | |
| | ABRASION | A | A | A | A | A |
| | RESISTANCE | | | | | |
| | | EXAMPLE 21 | EXAMPLE 22 | EXAMPLE 23 | EXAMPLE 24 | EXAMPLE 25 |
| BLACK INK COMPOSITION | | B01 | E01 | B01 | B01 | B01 |
| CHROMATIC INK COMPOSITION | | C03 | C04 | C06 | C07 | C08 |
| SILICONE-BASED SURFACTANT AMOUNT | | Y | Y | Y | Y | Y |
| Bk < COLOR | | | | | | |
| TYPE OF RECORDING MEDIUM | | M1 | M1 | M1 | M1 | M1 |
| MEDIUM SURFACE TEMPERATURE (° C.) | | 45 | 45 | 45 | 45 | 45 |
| VENTILATION (WIND SPEED m/s) | | 2 | 2 | 2 | 2 | 2 |
| WIND TEMPERATURE (° C.) | | 25 | 25 | 25 | 25 | 25 |
| IMAGE QUALITY (BOUNDARY BLEEDING) | | B | A | B | B | B |
| Bk | IMAGE QUALITY | A | A | A | A | A |
| IMAGE | (OD VALUE) | | | | | |
| QUALITY | IMAGE QUALITY | B | B | B | B | B |
| | (IRREGULARITY) | | | | | |
| | ABRASION | B | B | B | B | B |
| | RESISTANCE | | | | | |
| COLOR | IMAGE QUALITY | B | A | A | A | B |
| IMAGE | (OD VALUE) | | | | | |
| QUALITY | IMAGE QUALITY | B | A | B | C | D |
| | (IRREGULARITY) | | | | | |
| | ABRASION | A | B | B | B | B |
| | RESISTANCE | | | | | |
| | | EXAMPLE 26 | EXAMPLE 27 | EXAMPLE 28 | EXAMPLE 29 | EXAMPLE 30 |
| BLACK INK COMPOSITION | | B01 | B01 | B01 | B01 | B06 |
| CHROMATIC INK COMPOSITION | | C11 | C12 | C13 | C14 | C01 |
| SILICONE-BASED SURFACTANT AMOUNT | | Y | Y | Y | Y | Y |
| Bk < COLOR | | | | | | |
| TYPE OF RECORDING MEDIUM | | M1 | M1 | M1 | M1 | M1 |
| MEDIUM SURFACE TEMPERATURE (° C.) | | 45 | 45 | 45 | 45 | 40 |
| VENTILATION (WIND SPEED m/s) | | 2 | 2 | 2 | 2 | 2 |
| WIND TEMPERATURE (° C.) | | 25 | 25 | 25 | 25 | 25 |
| IMAGE QUALITY (BOUNDARY BLEEDING) | | C | C | A | A | C |
| Bk | IMAGE QUALITY | A | A | A | A | A |
| IMAGE | (OD VALUE) | | | | | |
| QUALITY | IMAGE QUALITY | B | B | B | B | B |
| | (IRREGULARITY) | | | | | |
| | ABRASION | B | B | B | B | B |
| | RESISTANCE | | | | | |
| COLOR | IMAGE QUALITY | A | A | C | A | A |
| IMAGE | (OD VALUE) | | | | | |
| QUALITY | IMAGE QUALITY | A | A | C | A | B |
| | (IRREGULARITY) | | | | | |
| | ABRASION | A | A | B | B | A |
| | RESISTANCE | | | | | |

TABLE 6

| | | EXAMPLE 31 | EXAMPLE 32 | EXAMPLE 33 | EXAMPLE 34 | EXAMPLE 35 |
|---|---|---|---|---|---|---|
| BLACK INK COMPOSITION | | B06 | B06 | B06 | B06 | B01 |
| CHROMATIC INK COMPOSITION | | C01 | C01 | C01 | C01 | C01 |
| SILICONE-BASED SURFACTANT AMOUNT | | Y | Y | Y | Y | Y |
| Bk < COLOR | | | | | | |
| TYPE OF RECORDING MEDIUM | | M1 | M1 | M1 | M1 | M1 |
| MEDIUM SURFACE TEMPERATURE (° C.) | | 50 | 45 | 45 | 45 | 25 |
| VENTILATION (WIND SPEED m/s) | | 2 | 5 | 1 | 2 | 10 |
| WIND TEMPERATURE (° C.) | | 25 | 25 | 25 | 40 | 25 |
| IMAGE QUALITY (BOUNDARY BLEEDING) | | A | A | C | A | C |
| Bk | IMAGE QUALITY | B | A | A | B | A |
| IMAGE | (OD VALUE) | | | | | |
| QUALITY | IMAGE QUALITY | A | B | B | A | B |
| | (IRREGULARITY) | | | | | |
| | ABRASION | B | B | B | B | B |
| | RESISTANCE | | | | | |
| COLOR | IMAGE QUALITY | B | B | B | B | A |
| IMAGE | (OD VALUE) | | | | | |
| QUALITY | IMAGE QUALITY | A | B | B | C | B |
| | (IRREGULARITY) | | | | | |
| | ABRASION | A | A | A | A | A |
| | RESISTANCE | | | | | |
| | | COMPAR- | COMPAR- | COMPAR- | COMPAR- | COMPAR- |
| | | ATIVE | ATIVE | ATIVE | ATIVE | ATIVE |
| | | EXAMPLE 1 | EXAMPLE 2 | EXAMPLE 3 | EXAMPLE 4 | EXAMPLE 5 |
| BLACK INK COMPOSITION | | B16 | E17 | B18 | B01 | B01 |
| CHROMATIC INK COMPOSITION | | C01 | C01 | C01 | C02 | C05 |
| SILICONE-BASED SURFACTANT AMOUNT | | Y | Y | Y | N | N |
| Bk < COLOR | | | | | | |
| TYPE OF RECORDING MEDIUM | | M1 | M1 | M1 | M1 | M1 |
| MEDIUM SURFACE TEMPERATURE (° C.) | | 45 | 45 | 45 | 45 | 45 |
| VENTILATION (WIND SPEED m/s) | | 2 | 2 | 2 | 2 | 2 |
| WIND TEMPERATURE (° C.) | | 25 | 25 | 25 | 25 | 25 |
| IMAGE QUALITY (BOUNDARY BLEEDING) | | B | B | B | D | D |
| Bk | IMAGE QUALITY | D | D | D | A | A |
| IMAGE | (OD VALUE) | | | | | |
| QUALITY | IMAGE QUALITY | D | D | D | B | B |
| | (IRREGULARITY) | | | | | |
| | ABRASION | B | B | D | B | B |
| | RESISTANCE | | | | | |
| COLOR | IMAGE QUALITY | B | B | B | C | D |
| IMAGE | (OD VALUE) | | | | | |
| QUALITY | IMAGE QUALITY | B | B | B | C | D |
| | (IRREGULARITY) | | | | | |
| | ABRASION | A | A | A | A | A |
| | RESISTANCE | | | | | |
| | | COMPAR- | COMPAR- | COMPAR- | | |
| | | ATIVE | ATIVE | ATIVE | REFERENCE | REFERENCE |
| | | EXAMPLE 6 | EXAMPLE 7 | EXAMPLE 8 | EXAMPLE 1 | EXAMPLE 2 |
| BLACK INK COMPOSITION | | B01 | B01 | B17 | B01 | B01 |
| CHROMATIC INK COMPOSITION | | C09 | C10 | C02 | C01 | C02 |
| SILICONE-BASED SURFACTANT AMOUNT | | Y | Y | Y | Y | N |
| Bk < COLOR | | | | | | |
| TYPE OF RECORDING MEDIUM | | M1 | M1 | M1 | M2 | M2 |
| MEDIUM SURFACE TEMPERATURE (° C.) | | 45 | 45 | 45 | 45 | 45 |
| VENTILATION (WIND SPEED m/s) | | 2 | 2 | 2 | 2 | 2 |
| WIND TEMPERATURE (° C.) | | 25 | 25 | 25 | 25 | 25 |
| IMAGE QUALITY (BOUNDARY BLEEDING) | | D | D | B | A | B |
| Bk | IMAGE QUALITY | A | A | D | B | B |
| IMAGE | (OD VALUE) | | | | | |
| QUALITY | IMAGE QUALITY | B | B | D | A | B |
| | (IRREGULARITY) | | | | | |
| | ABRASION | B | B | B | D | D |
| | RESISTANCE | | | | | |
| COLOR | IMAGE QUALITY | A | C | C | A | B |
| IMAGE | (OD VALUE) | | | | | |
| QUALITY | IMAGE QUALITY | A | B | C | B | B |
| | (IRREGULARITY) | | | | | |
| | ABRASION | A | A | A | D | D |
| | RESISTANCE | | | | | |

### 3.5. Evaluation Method

In each of Examples, Comparative Examples, and Reference Examples, evaluation tests on the image quality (boundary bleeding), the image quality (OD value), the image quality (irregularity), and the abrasion resistance were performed. Hereinafter, the methods thereof will be described.

In addition, the evaluation on the image quality was performed from a recording surface side. In addition, except for the image quality (boundary bleeding), the evaluation test was performed by a pattern recorded by the recording method described above only using a single ink composition.

### 3.5.1. Image Quality (Boundary Bleeding)

A recorded matter having a lattice pattern with a width of 1 mm printed by the recording method described above was observed by visual inspection and was then determined by the following evaluation criteria. In addition, by the evaluation test on the image quality (boundary bleeding), the inter-color mixing between the inks can be evaluated.

### Evaluation Criteria

A: No boundary bleeding is visually recognized, and lattice widths of colors are not different from each other.
B: Although no boundary bleeding is visually recognized, lattice widths of colors are different from each other.
C: Boundary bleeding is visually recognized.
D: Boundary bleeding is conspicuous.

### 3.5.2. Image Quality (Od Value)

An OD value of a solid image of a recorded matter obtained by the recording method described above was measured under the following measurement conditions using a colorimeter (i1Pro2, manufactured by X-rite) and was then determined by the following evaluation criteria. In addition, by the evaluation test on the image quality (OD value), the wet spreadability of the ink can be evaluated. MEASUREMENT CONDITIONS Measurement device: i1Pro2 (manufactured by X-rite) Measurement conditions: D50 light source, status T, and standard 2 degree observer.

Background: white paper

### Evaluation Criteria

A: OD value of 1.2 or more
B: OD value of 1.0 to less than 1.2
C: OD value of 0.8 to less than 1.0
D: OD value of 0.6 to less than 0.8

### 3.5.3. Image Quality (Irregularity)

A solid image of a recorded matter obtained by the recording method described above was observed by visual inspection and was then determined by the following evaluation criteria. In addition, although the image quality (irregularity) was liable to be degraded when the wet spreadability of the ink was inferior, it should be noted that factors, such as the drying property, of the ink other than the wet spreadability also relate to the image quality (irregularity).

### Evaluation Criteria

A: No density irregularity is observed in pattern.
B: Small density irregularity is slightly observed.
C: Small density irregularity is apparently observed.
D: large density irregularity is observed.

### 3.5.4. Abrasion Resistance

A test (JIS P 8136) was performed such that a solid portion of a pattern of a recorded matter obtained by the recording method described above was reciprocally rubbed 50 times by a white cloth No. 3 with a load of 500 g using a Gakushin-type rubbing fastness tester AB-301 (manufactured by Tester Sangyo Co., Ltd.), and the result thus obtained was determined by the following evaluation criteria.

### Evaluation Criteria

A: No image peeling is observed.
B: Less than 10% is peeled off.
C: 10% to Less than 40% is peeled off.
D: 40% or more is peeled off, and recording medium was broken.

### 3.6. Evaluation Results

Evaluation results are shown in the above Tables 4 to 6.

From the above Tables 4 to 6, it was found that by the ink set of each Example which includes a black ink composition containing a black colorant and a chromatic ink composition containing a colorant and which is used for recording on a low-absorbing recording medium or a non-absorbing recording medium, the black ink composition and the chromatic ink composition each being a water-based ink jet ink, the chromatic ink composition containing a silicone-based surfactant 1 in which the maximum peak in a molecular weight range of 300 or more is located in a range of 3,000 to 20,000 in a molecular weight distribution by a gel permeation chromatography, and the black ink composition containing at least one selected from a glycol monoether solvent and a silicone-based surfactant 2 in which the maximum peak in a molecular weight range of 300 or more is located in a range of 300 to 1,500 in a molecular weight distribution by a gel permeation chromatography, since the black ink composition is excellent in wet spreadability, the image quality (OD value) is made excellent, and in addition, since the color mixing between the black ink composition and the chromatic ink composition can be significantly reduced, the image quality (boundary bleeding) is made excellent.

By the comparison between Example 1 and Comparative Examples 1 to 3, it was found that when the black ink composition contains the glycol monoether solvent or the specific silicone-based surfactant 2, the wet spreadability is made excellent, and the image quality (OD value) and the image quality (irregularity) of the black ink composition are made excellent.

By the comparison between Example 1 and Comparative Examples 4 to 7, it was found that when the chromatic ink composition contains the specific silicone-based surfactant 1, the color mixing between the black ink composition and the chromatic ink composition can be significantly reduced, and the image quality (boundary bleeding) can be made excellent.

By the comparison between Example 1 and Comparative Example 8, it was found that when the black ink composition contains the glycol monoether solvent or the specific silicone-based surfactant 2, and the chromatic ink composition contains the specific silicone-based surfactant 1, since the black ink composition is excellent in wet spreadability, the image quality (OD value) is made excellent, and in addition, since the color mixing between the black ink composition and the chromatic ink composition can be significantly reduced, the image quality (boundary bleeding) is made excellent, so that the above two types of image qualities can be simultaneously satisfied.

In addition, from the results of Example 1 and Reference Examples 1 to 2, in the recording on the low-absorbing recording medium or the non-absorbing recording medium, the problem relating to the present disclosure is generated.

From the results of Examples 1, 2, and 18, it was found that when the content of the specific silicone-based surfactant 2 in the black ink composition is in a predetermined range, for example, the image quality (boundary bleeding) and the image quality (OD value) of the black ink composition are made excellent.

From the results of Examples 1 and 3, it was found that when the black ink composition further contains the specific silicone-based surfactant 1, the wet spreadability of the black ink composition and the inter-color mixing can be simultaneously made more excellent.

From the results of Examples 1, 4, and 5, it was found that when the content of the glycol monoether solvent in the black ink composition is in a predetermined range, for example, the image quality (boundary bleeding) and the image quality (OD value) of the black ink composition are made excellent.

From the results of Examples 6 and 7, it was found that even when the black ink composition contains only the glycol monoether solvent out of the glycol monoether solvent and the specific silicone-based surfactant 2, the image quality (boundary bleeding) and the image quality (OD value) of the black ink composition can be simultaneously made excellent.

From the results of Examples 1, 8, and 9, it was found that by using various types of glycol monoether solvents for the black ink composition, the image quality (boundary bleeding) and the image quality (OD value) of the black ink composition can be simultaneously made excellent.

From the results of Examples 1, 10 to 15, and 23, it was found that by using various types of organic solvents for the black ink composition, the image quality (boundary bleeding) and the image quality (OD value) of the black ink composition can be simultaneously made excellent.

From the result of Example 16, it was found that even when the black ink composition contains only the specific silicone-based surfactant 2 out of the glycol monoether solvent and the specific silicone-based surfactant 2, the image quality (boundary bleeding) and the image quality (OD value) of the black ink composition can be simultaneously made excellent.

From the results of Examples 1 and 17, it was found that by using various types of specific silicone-based surfactants 2 for the black ink composition, the image quality (boundary bleeding) and the image quality (OD value) of the black ink composition can be simultaneously made excellent.

From the results of Examples 1, 19, and the like, it was found that when the content of the organic solvent in the black ink composition is in a predetermined range, the image quality (boundary bleeding), the abrasion resistance of the black ink composition, and the image quality (irregularity) thereof can be made preferable.

From the results of Examples 1, 21, and 29, it was found that when the chromatic ink composition contains no specific silicone-based surfactant 2, the image quality (boundary bleeding) tends to be made more excellent.

From the results of Examples 1, 22, 27, and 28, it was found that when the content of the specific silicone-based surfactant 1 in the chromatic ink composition is in a predetermined range, the image quality (boundary bleeding) is made excellent.

From the results of Examples 1 and 23 to 25, it was found that when the chromatic ink composition contains the glycol monoether solvent, while the wet spreadability of the chromatic ink composition is enhanced, the image quality (boundary bleeding) also tends to be made excellent.

From the results of Examples 1 and 26, it was found that by using various types of specific silicone-based surfactants 1 for the chromatic ink composition, the image quality (boundary bleeding) is made excellent.

From the results of Examples 1, 6, and 30 to 35, it was found that under various recording conditions, the image quality (boundary bleeding) and the image quality (OD value) of the black ink composition can be simultaneously made excellent.

From the embodiments described above, the following conclusions are obtained.

An ink set according to one aspect of the present disclosure includes a black ink composition containing a black colorant and a chromatic ink composition containing a colorant and is used for recording on a low-absorbing recording medium or a non-absorbing recording medium. In the ink set described above, the black ink composition and the chromatic ink composition are each a water-based ink jet ink, the chromatic ink composition contains a silicone-based surfactant 1 in which in a molecular weight distribution by a gel permeation chromatography, the maximum peak in a molecular weight range of 300 or more is located in a range of 3,000 to 20,000, and the black ink composition contains at least one selected from a glycol monoether solvent and a silicone-based surfactant 2 in which in a molecular weight distribution by a gel permeation chromatography, the maximum peak in a molecular weight range of 300 or more is located in a range of 300 to 1,500.

In the ink set according to the aspect described above, the black ink composition contains the glycol monoether solvent, and the glycol monoether solvent may be a glycol monoether including an alkyl ether portion which has 5 carbon atoms or more or 2 carbon atoms or less.

In the ink set according to the aspect described above, a content of the glycol monoether solvent may be 2 percent by mass or less with respect to a total mass of the black ink composition.

In the ink set according to the aspect described above, a total content of a silicone-based surfactant including the silicone-based surfactant 1 in the chromatic ink composition may be higher than a total content of a silicone-based surfactant including the silicone-based surfactant 2 in the black ink composition.

In the ink set according to the aspect described above, the silicone-based surfactant 1 may have a structure represented by the following general formula (1) or (3).

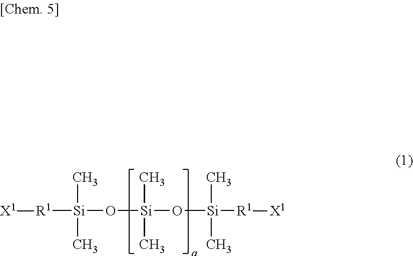

In the general formula (1), R¹'s each independently represent an alkylene group having 1 to 6 carbon atoms or a single bond, X¹'s each independently represent a polyether group represented by the following general formula (2), and a represents an integer of 10 to 80.

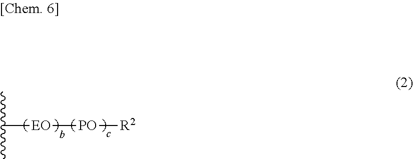

In the general formula (2), R² represents a hydrogen atom, an alkyl group having 1 to 6 carbon atoms, or a (meth)acrylic group, EO represents an ethylene oxide group, PO represents a propylene oxide group, the order of (EO)_{b}, and (PO)_{c} is an arbitrary order, b represents an integer of 0 or more, c represents an integer of 0 or more, and b+c represents an integer of 1 or more.

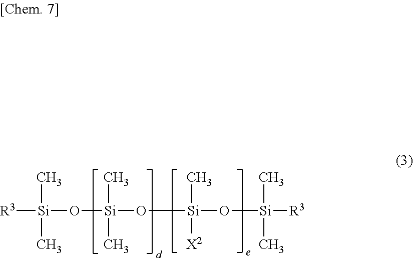

In the general formula (3), R³'s each independently represent an alkyl group having 1 to 6 carbon atoms, X²'s each independently represent a polyether group represented by the following general formula (4), d and e each represent an integer of 1 or more, and d+e represents an integer of 2 to 50.

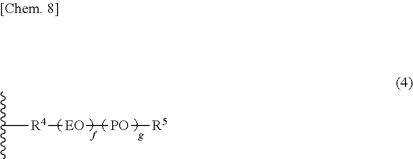

In the general formula (4), R⁴ represents an alkylene group having 1 to 6 carbon atoms or a single bond, R⁵ represents a hydrogen atom or an alkyl group having 1 to 6 carbon atoms, EO represents an ethylene oxide group, PO represents a propylene oxide group, the order of (EO)_{f} and (PO)_{g} is an arbitrary order, f represents an integer of 0 or more, g represents an integer of 0 or more, and f+g represents an integer of 1 or more.

In the ink set according to the aspect described above, the black ink composition may contain the glycol monoether solvent and the silicone-based surfactant 2.

In the ink set according to the aspect described above, the black ink composition and the chromatic ink composition each contain an organic solvent, and a content of an organic solvent having a standard boiling point of less than 200° C. may be 50 parts by mass or more with respect to total 100 parts by mass of the organic solvent.

In the ink set according to the aspect described above, the black ink composition and the chromatic ink composition each contain an organic solvent, and a content of the organic solvent may be 5 to 30 percent by mass with respect to a total mass of the ink composition.

In the ink set according to the aspect described above, the black ink composition and the chromatic ink composition each contain at least one organic solvent, and among the organic solvents contained in the ink composition, an organic solvent having the highest standard boiling point may have a standard boiling point of 250° C. or less.

A recording method according to another aspect of the present disclosure performs recording using the ink set according to the aspect described above on a recording medium which is a low-absorbing recording medium or a non-absorbing recording medium and comprises: a black ink adhesion step of adhering the black ink composition to the recording medium by an ink jet method; and a chromatic ink adhesion step of adhering the chromatic ink composition to the recording medium by an ink jet method.

The recoding method according to the aspect described above may further comprise a primary drying step of drying the black ink composition and the chromatic ink composition each adhered to the recording medium.

In the recoding method according to the aspect described above, the primary drying step performs the drying by ventilation, and the ventilation may be performed at a wind speed of 0.5 to 15 m/s.

In the recoding method according to the aspect described above, in the primary drying step, the recording medium may have a surface temperature of 45° C. or less.

The present disclosure is not limited to the embodiments described above and may be variously changed and modified. For example, the present disclosure includes substantially the same structure as the structure described in the embodiment. That is, the substantially the same structure includes, for example, the structure in which the function, the method, and the result are the same as those described above, or the structure in which the object and the effect are the same as those described above. In addition, the present disclosure includes the structure in which a nonessential portion of the structure described in the embodiment is replaced with something else. In addition, the present disclosure includes the structure which performs the same operational effect as that of the structure described in the embodiment or the structure which is able to achieve the same object as that of the structure described in the embodiment. In addition, the present disclosure includes the structure in which a known technique is added to the structure described in the embodiment.

What is claimed is:

1. An ink set which includes a black ink composition containing a black colorant and a chromatic ink composition containing a colorant and which is used for recording on a low-absorbing recording medium or a non-absorbing recording medium,
wherein the black ink composition and the chromatic ink composition are each a water-based ink jet ink,
the chromatic ink composition contains a silicone-based surfactant 1 in which in a molecular weight distribution by a gel permeation chromatography, the maximum peak in a molecular weight range of 300 or more is located in a range of 3,000 to 20,000, and
the black ink composition contains at least one selected from a glycol monoether solvent and a silicone-based surfactant 2 in which in a molecular weight distribution by a gel permeation chromatography, the maximum peak in a molecular weight range of 300 or more is located in a range of 300 to 1,500.

2. The ink set according to claim 1,
wherein the black ink composition contains the glycol monoether solvent, and
the glycol monoether solvent is a glycol monoether including an alkyl ether portion which has 5 carbon atoms or more or 2 carbon atoms or less.

3. The ink set according to claim 1,
wherein a content of the glycol monoether solvent is 2 percent by mass or less with respect to a total mass of the black ink composition.

4. The ink set according to claim 1,
wherein a total content of a silicone-based surfactant including the silicone-based surfactant 1 in the chromatic ink composition is higher than a total content of a silicone-based surfactant including the silicone-based surfactant 2 in the black ink composition.

5. The ink set according to claim 1,
wherein the silicone-based surfactant 1 has a structure represented by the following general formula (1) or (3), 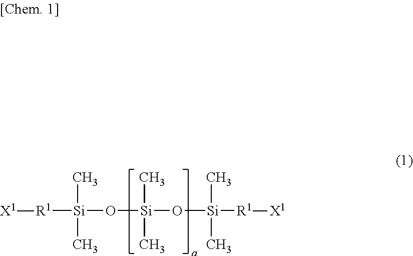
where in the general formula (1), R¹'s each independently represent an alkylene group having 1 to 6 carbon atoms or a single bond, X¹'s each independently represent a polyether group represented by the following general formula (2), and a represents an integer of 10 to 80, 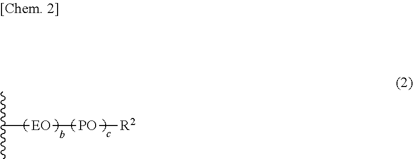
where in the general formula (2), R² represents a hydrogen atom, an alkyl group having 1 to 6 carbon atoms, or a (meth)acrylic group, EO represents an ethylene oxide group, PO represents a propylene oxide group, the order of (EO)_{b}, and (PO)_{c} is an arbitrary order, b represents an integer of 0 or more, c represents an integer of 0 or more, and b+c represents an integer of 1 or more, 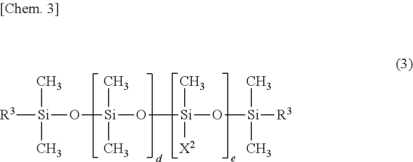
where in the general formula (3), R³'s each independently represent an alkyl group having 1 to 6 carbon atoms, X²'s each independently represent a polyether group represented by the following general formula (4), d and e each represent an integer of 1 or more, and d+e represents an integer of 2 to 50, 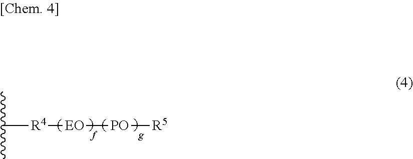
where in the general formula (4), R⁴ represents an alkylene group having 1 to 6 carbon atoms or a single bond, R⁵ represents a hydrogen atom or an alkyl group having 1 to 6 carbon atoms, EO represents an ethylene oxide group, PO represents a propylene oxide group, the order of (EO)_{f} and (PO)_{g} is an arbitrary order, f represents an integer of 0 or more, g represents an integer of 0 or more, and f+g represents an integer of 1 or more.

6. The ink set according to claim 1,
wherein the black ink composition contains the glycol monoether solvent and the silicone-based surfactant 2.

7. The ink set according to claim 1,
wherein the black ink composition and the chromatic ink composition each contain an organic solvent, and
a content of an organic solvent having a standard boiling point of less than 200° C. is 50 parts by mass or more with respect to total 100 parts by mass of the organic solvent.

8. The ink set according to claim 1,
wherein the black ink composition and the chromatic ink composition each contain an organic solvent, and
a content of the organic solvent is 5 to 30 percent by mass with respect to a total mass of the ink composition.

9. The ink set according to claim 1,
wherein the black ink composition and the chromatic ink composition each contain at least one organic solvent, and
among the organic solvents contained in the ink composition, an organic solvent having the highest standard boiling point has a standard boiling point of 250° C. or less.

10. A recording method which performs recording using the ink set according to claim 1 on a recording medium which is a low-absorbing recording medium or a non-absorbing recording medium, the method comprising:
a black ink adhesion step of adhering the black ink composition to the recording medium by an ink jet method; and
a chromatic ink adhesion step of adhering the chromatic ink composition to the recording medium by an ink jet method.

11. The recording method according to claim 10,
further comprising a primary drying step of drying the black ink composition and the chromatic ink composition each adhered to the recording medium.

12. The recording method according to claim 11,
wherein the primary drying step performs the drying by ventilation, and
the ventilation is performed at a wind speed of 0.5 to 15 m/s.

13. The recording method according to claim 11,
wherein in the primary drying step, the recording medium has a surface temperature of 45° C. or less.
